(19) United States
(12) Patent Application Publication
(10) Pub. No.: US 2026/0094732 A1
(43) Pub. Date: Apr. 2, 2026

(54) MOBILE DATA CENTER POWERED BY NUCLEAR AND RENEWABLE ENERGY

(71) Applicants: Jonathan HAASE, Alexandria, VA (US); Zachary TOWNSEND, San Francisco, CA (US)

(72) Inventors: Jonathan HAASE, Alexandria, VA (US); Zachary TOWNSEND, San Francisco, CA (US)

(21) Appl. No.: 19/342,975

(22) Filed: Sep. 29, 2025

Related U.S. Application Data
(60) Provisional application No. 63/702,580, filed on Oct. 2, 2024.

(51) Int. Cl. G21D 1/00; G21D 1/02; G21D 3/04

(52) U.S. Cl. CPC G21D 1/00; G21D 1/02; G21D 3/04

(57) ABSTRACT

A mobile nuclear-powered data center system, comprising a mobile platform configured for transport to and deployment at a predetermined remote site; a nuclear reactor assembly mounted on the mobile platform, the reactor assembly comprising a nuclear reactor configured to generate electric power, a containment structure enclosing the nuclear reactor for safety, and a cooling subsystem for removing heat dissipated from the nuclear reactor; a data center module mounted on the platform, the data center module comprising a plurality of computing servers, data storage devices, and networking equipment; an energy storage and backup subsystem configured to store excess electrical energy generated during periods of low computing load and to supply supplemental electrical power to the data center module during periods of high load or the nuclear reactor shutdown; and one or more safety subsystems mounted on the platform to protect personnel and equipment.

### CROSS-REFERENCE TO RELATED APPLICATIONS

This application claims priority to and the benefit of co-pending U.S. Provisional Application Ser. No. 63/702,580, filed Oct. 2, 2024, the contents of which are incorporated by reference herein in its entirety and for all purposes.

### TECHNICAL FIELD

Embodiments of the disclosure generally relate to data center infrastructure and power systems, and more particularly, to a mobile data center powered by a nuclear energy source and one or more renewable energy sources.

### BACKGROUND

Data centers are crucial for business continuity for many modern businesses and institutions. A data center is a facility that houses computer systems and associated components to manage and disseminate data for various organizations' information technology (IT) operations. In particular, the data center may include a large number of computing server racks, telecommunications equipment, and storage systems to accommodate the rapid growth of cloud computing, artificial intelligence (AI), and high-performance computing (HPC) applications. Thus, the rapid growth has created an unprecedented demand for energy-efficient data centers. Traditional land-based data centers face numerous issues, including high power consumption, poor cooling efficiency, and data security challenges, particularly in sensitive industries such as defense, finance, and military operations. Furthermore, traditional land-based data centers struggle to implement a suitable data center infrastructure that meets the increasing demand for electricity to support HPC/AI workflows driven by multiple cutting-edge AI technologies in different geographic locations. For example, data centers consume enormous amounts of electricity, ranging from 5% to 10% of total US electricity. The power demand by data centers is relatively stable during the day compared to the power demand from residences or many other businesses. As another example, the power demand for both industrial applications and data centers may fluctuate based on various business factors, such as the time of day or season. As a result, there is a need to develop new, reliable power solutions for data centers to expand traditional grids for improved capacity and efficiency.

Nuclear power provides steady, zero-carbon baseload electricity that is well-suited for the around-the-clock power demand of data centers. In particular, nuclear power plants produce electricity without directly emitting carbon dioxide, thus making them a large source of CO2 emission-free power. Likewise, renewable energy sources, such as solar and wind, offer carbon-free power but are intermittent, requiring complementary baseload sources or storage. It is highly desirable to develop a variable energy source by combining various low-carbon, high-reliability power sources for data centers, thereby achieving both expansion and sustainability goals.

### SUMMARY

The following presents a simplified summary of the disclosed subject matter in order to provide a basic understanding of some aspects of the subject matter disclosed herein. This summary is not an exhaustive overview of the technology disclosed herein. It is not intended to identify key or critical elements of the disclosed subject matter or to delineate the scope of the disclosed subject matter. Its sole purpose is to present some concepts in a simplified form as a prelude to the more detailed description that is discussed later.

In one or more embodiments, the present invention provides a mobile nuclear-powered data center system. The mobile nuclear-powered data center system includes a mobile platform configured for transport to and deployment at a predetermined location. The mobile platform has infrastructure to support both nuclear power generation and data center operation. The mobile platform is a floating vessel or barge structured to comply with maritime safety standards for nuclear-powered ships, comprising compliance with Safety of Life at Sea (SOLAS) Chapter VIII and class society rules for nuclear vessel design, such that the mobile platform is deployed in harbors or international waters with regulatory approval. The data center module comprises a communication interface for data connectivity, the communication interface comprising at least one high-bandwidth fiber optic link or satellite communication system, allowing the data center module to serve remote clients or integrate into a wider network.

In one or more embodiments, the mobile nuclear-powered data center system further includes a nuclear reactor assembly mounted on the mobile platform. The nuclear reactor assembly comprises a nuclear reactor configured to generate electric power, a containment structure enclosing the reactor for safety, and a first cooling subsystem for removing heat dissipated from the nuclear reactor. The nuclear reactor assembly is a small modular reactor (SMR) with a thermal power output between 10 megawatts thermal (MWt) and 300 MWt, and is designed for inherent safety through passive cooling and autonomous shutdown. The nuclear reactor assembly further uses a high-assay low-enriched uranium fuel to allow a core operation lifespan of at least 3 years between refuelings.

In one or more embodiments, the mobile nuclear-powered data center system further includes a data center module mounted on the mobile platform comprising a plurality of computing servers, data storage devices, and networking equipment. The data center module has an onboard power distribution subsystem to supply power to a plurality of computing servers. The mobile nuclear-powered data center system further includes an electrical interface electrically coupling the nuclear reactor assembly to the onboard power distribution subsystem of the data center module, such that the plurality of computing servers are powered at least in part by electricity generated by the nuclear reactor. The mobile nuclear-powered data center system further includes an energy storage and backup subsystem integrated with the mobile platform to store excess electrical energy generated during periods of low computing load and to supply supplemental electrical power to the data center module during periods of high load or the nuclear reactor shutdown. The energy storage and backup subsystem comprises an electrolysis unit configured to use surplus electrical power from the nuclear reactor to generate hydrogen; a plurality of hydrogen storage tanks for storing the generated hydrogen; and one or more hydrogen fuel cells capable of converting the stored hydrogen back into electricity, so that the energy storage and backup subsystem provides a hydrogen-based energy buffer for load leveling and emergency power, thereby reducing the need for external grid support or fossil-fuel generators.

In one or more embodiments, the mobile nuclear-powered data center system further includes an integrated control component to monitor and regulate an electric power supply based on the computing demand for the data center module. The mobile nuclear-powered data center system further includes one or more safety subsystems mounted on the mobile platform. The one or more safety subsystems comprise radiation shielding, a reactor shutdown system, and an emergency cooling subsystem. The one or more safety systems are configured to ensure the nuclear reactor assembly operates within safe parameters and to protect personnel and equipment, thereby enabling the mobile platform to meet nuclear regulatory requirements for transportable or maritime reactors.

In one or more embodiments, the mobile nuclear-powered data center system further includes a renewable energy interface that allows the mobile platform to import or export electrical power to one or more external renewable energy sources. The mobile nuclear-powered data center system further includes a control system configured to dynamically balance power from the nuclear reactor and the one or more external renewable energy sources to maintain continuous power to the data center module. The mobile nuclear-powered data center system further includes an integrated cooling subsystem by combining the first cooling subsystem for the nuclear reactor assembly with a second cooling subsystem for the data center module using a common heat sink. The integrated cooling subsystem uses seawater pumps and heat exchangers to dissipate reactor waste heat and cool the data center equipment, enabling high-efficiency heat removal and eliminating the need for large cooling towers on the mobile platform.

In one or more embodiments, the mobile nuclear-powered data center system further includes a remote monitoring subsystem that is automated to adjust a plurality of operations for the nuclear reactor and the data center module. The plurality of operations are determined by using redundant sensors and control algorithms that manage reactor power levels, data center power usage, and safety interlocks without continuous human intervention. The mobile nuclear-powered data center system further includes a plurality of modular connectors and coupling mechanisms that allow a plurality of mobile nuclear-powered data center subsystems to be linked together electrically and/or mechanically when deployed, thereby forming a larger aggregated data center complex with increased computing and power capacity.

In one or more embodiments, the present invention provides a method of deploying a mobile nuclear-powered data center platform. The method includes transporting the mobile nuclear-powered data center platform that includes a nuclear reactor assembly and a data center module to a first location, the reactor assembly comprising a nuclear reactor configured to generate electric power. The method further includes mooring or installing the mobile nuclear-powered data center platform at the first location and initiating the nuclear reactor assembly to generate electric power in a power supply for a plurality of computing servers associated with the data center module. The method further includes powering, using an electrical interface, electrically coupling the nuclear reactor assembly to the onboard power distribution subsystem of the data center module, the plurality of computing servers associated with the data center module at least in part by the electric power generated by the nuclear reactor assembly. The method further includes receiving, using an integrated control component, a computing demand for the data center module from a user. The method further includes monitoring and regulating, using the integrated control component, the electric power supply based on the computing demand. The method further includes implementing, using one or more safety subsystems, a plurality of safety and security protocols during an operation of the mobile nuclear-powered data center platform, the operation comprising continuous cooling of the nuclear reactor, radiation monitoring, and the capability to reactor protection system actuation (SCRAM) the nuclear reactor in case of emergency, and maintaining secure network communication for the data center module. The method further includes receiving, using the integrated control system, a command to transport the mobile nuclear-powered data center platform to a second location. Upon receiving the command, the method further includes relocating the mobile nuclear-powered data center platform from the first location to the second location by implementing a plurality of steps comprising ceasing data operations, shutting down the nuclear reactor to a safe transport state, and moving the mobile nuclear-powered data center platform. The first and second locations include a port or coastal site within a country, an offshore position in international waters, and a remote land site lacking grid infrastructure.

In one or more embodiments, the method further includes directing, using the integrated control component, excess power to an energy storage and backup subsystem when the computing demand is lower than a current power output from the nuclear power module. The method further includes directing, using the integrated control component, supplemental power from the energy storage and backup subsystem, or by adjusting current power output from the nuclear power module. The method further includes activating a communications link from the mobile nuclear-powered data center platform to a land-based network hub to transfer data from the mobile nuclear-powered data center platform to the user. The method further includes connecting an output feeder from the onboard power distribution subsystem to an external facility. The method further includes supplying auxiliary power to the external facility without interrupting the electric power supply for the data center module. The method further includes measuring a change in the computing demand for the data center module. In response to detecting the change, the method further includes dynamically controlling, using a feedback loop, a power level of the nuclear reactor by adjusting control rods or coolant flow in the nuclear reactor to increase/decrease electrical generation, within predetermined safe ramping rates, thereby accomplishing fine-grained load following to minimize reliance on stored energy. The method further includes periodically performing maintenance and refueling operations for the nuclear reactor assembly on-site or at a refueling facility.

In one or more embodiments, the present invention provides a transportable data center platform. The transportable data center platform includes a structural body adapted for transit and redeployment, the body housing both (i) a power generation section containing a nuclear reactor and associated power conversion hardware, and (ii) a data processing section containing racks of computing equipment. The transportable data center platform further includes a plurality of modular connection points on the body for external interfaces, comprising at least one power interface for connecting to an external electrical grid or renewable energy source, and at least one data interface for connecting to telecommunications networks. The transportable data center platform includes a hybrid power management system that controls the distribution of electrical power from the power generation section to the data processing section and the external power interface, the power management system comprising control circuitry to manage power flows, energy storage utilization, and failover to backup power. The nuclear reactor in the power generation section is an inherently safe microreactor designed to have a limited emergency planning zone contained within the transportable platform, and the platform is constructed to comply with at least one national or international nuclear safety standard applicable to mobile reactors. The data processing section is configured to operate as a secure data center environment with controlled temperature, humidity, and physical security, such that the entire platform can provide data center services independently of location while meeting applicable safety, security, and liability requirements for nuclear-powered operations.

In one or more embodiments, the nuclear reactor is a fusion reactor or an advanced fission reactor that produces minimal long-lived radioactive waste. The transportable data center platform further comprises a radiation-hardened infrastructure for the data processing section, comprising electronic components and shielding that protect the computing equipment from any residual radiation or electromagnetic interference emitted by the reactor section. A plurality of transportable data center platforms are aggregated to form a distributed cloud network, each platform located in a corresponding geographic region and interconnected via high-speed data links.

Other aspects and advantages of the claimed subject matter will be apparent from the following description and the appended claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a mobile semi-submerged data center platform in accordance with one or more embodiments.

FIG. 2 illustrates a mobile submerged data center platform in accordance with one or more embodiments.

FIG. 3 illustrates a data center power topology of a mobile nuclear-powered data center platform in accordance with one or more embodiments.

FIG. 4 illustrates a diagram of key safety and regulatory compliance features in accordance with one or more embodiments.

FIG. 5 illustrates an information technology (IT) infrastructure by reactor class and rack configuration in accordance with one or more embodiments.

FIG. 6 illustrates a decision-making framework of a mobile nuclear-powered data center platform in accordance with one or more embodiments.

FIG. 7 illustrates a functional block diagram of a computer system in accordance with one or more embodiments.

While certain embodiments will be described in connection with the illustrative embodiments shown herein, the subject matter of the present disclosure is not limited to those embodiments. On the contrary, all alternatives, modifications, and equivalents are included within the spirit and scope of the disclosed subject matter as defined by the claims. In the drawings, which are not to scale, the same reference numerals are used throughout the description and in the drawing figures for components and elements having the same structure.

### DETAILED DESCRIPTION

In the following description, for purposes of explanation, numerous specific details are set forth in order to provide a thorough understanding of the inventive concept. In the interest of clarity, not all features of an actual implementation are described. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” or “another embodiment” means that a particular feature, structure, or characteristic described in connection with the embodiment is included in at least one embodiment of the disclosed subject matter, and multiple references to “one embodiment” or “an embodiment” or “another embodiment” should not be understood as necessarily all referring to the same embodiment.

This disclosure pertains to a mobile nuclear-powered data center platform that provides a self-contained computing facility in a data center mounted on a mobile platform that is powered by an onboard nuclear power module including a nuclear reactor for deployment in remote locations, such as in a maritime environment. The self-contained computing facility includes a plurality of computing servers, data storage devices, networking equipment, and an onboard power distribution subsystem suitable for high-performance computing (HPC) and artificial intelligence (AI) workflows. The onboard nuclear power module is configured to include a nuclear reactor assembly mounted on the mobile platform. For example, the nuclear reactor assembly includes a small modular reactor (SMR) with a thermal power output between 10 megawatts thermal (MWt) and 300 MWt that is configured to generate electric power. Likewise, the nuclear assembly includes a containment structure enclosing the nuclear reactor for safety and a specialized cooling subsystem for removing heat dissipated from the nuclear reactor. An electrical interface is used to electrically couple the nuclear reactor assembly to the onboard power distribution subsystem of the data center module, such that the plurality of computing servers are powered at least in part by electricity generated by the nuclear reactor. Thus, the onboard nuclear power module provides reliable, high-density power to the self-contained computing facility in a transportable configuration suitable for deployment in remote locations, coastal waters, or international waters.

Furthermore, the mobile nuclear-powered data center platform combines a steady, zero-carbon baseload electricity output from the nuclear reactor or a hydrogen/fuel-cell cluster with on-platform hydrogen H₂ synthesis with one or more carbon-free, intermittent hybrid power solutions, such as hydrogen fuel cells and renewable energy sources, to generate an electric power supply that is monitored and regulated by an integrated control component based on a computing demand for the data center module. In particular, the one or more hybrid power solutions include one or more renewable energy sources, such as wind, solar, wave/tidal, and hydroelectric power, when the mobile nuclear-powered data center platform is deployed near an offshore wind farm or solar array. Thus, the mobile nuclear-powered data center platform accepts an additional input of renewable electricity, throttles down a baseload electricity output from the nuclear reactor or the hydrogen/fuel-cell cluster with on-platform hydrogen (H₂) synthesis, and generates hydrogen with a surplus of electricity stored in an energy storage and backup subsystem mounted on the mobile platform. As a result, the one or more hybrid power solutions alongside the nuclear reactor may largely enhance reliability and load-following capability for the data center. The mobile nuclear-powered data center platform may provide continuous low-carbon power and feed excess power to nearby facilities with a flexible commercial model, such as sale, lease, or data-as-a-service, enabled by its mobile data center infrastructure.

Furthermore, the mobile nuclear-powered data center platform includes one or more safety subsystems mounted on the mobile platform to meet maritime nuclear regulations and international nuclear liability frameworks. In particular, the one or more safety subsystems enforce an environmental discharge constraint limiting outlet seawater temperature rise to ≤5° C. above ambient measured at a distance ≤10 m from each discharge port, with automatic derating or depth adjustment when the constraint is approached. For example, the one or more safety subsystems include radiation shielding, a reactor shutdown subsystem, and an emergency cooling subsystem. The one or more safety subsystems are configured to ensure the reactor assembly operates within a plurality of safe parameters to protect personnel and equipment, thereby enabling the mobile nuclear-powered data center platform to meet nuclear regulatory requirements for transportable or maritime reactors. As a result, the mobile nuclear-powered data center platform may operate as a standalone data center that is safely deployed in different environments (land or sea) to meet or exceed regulatory safety standards by incorporating hybrid energy features for enhanced reliability.

Furthermore, the mobile nuclear-powered data center platform is designed to operate as one or more continuous, zero-carbon compute-near-demand centers with a minimal land footprint. The mobile nuclear-powered data center platform integrates advanced computational infrastructure powered by a baseload power module that may be nuclear or a hydrogen/fuel-cell cluster with on-platform H₂ synthesis for a disaster-resilient edge region to generate exportable auxiliary power for a power grid.

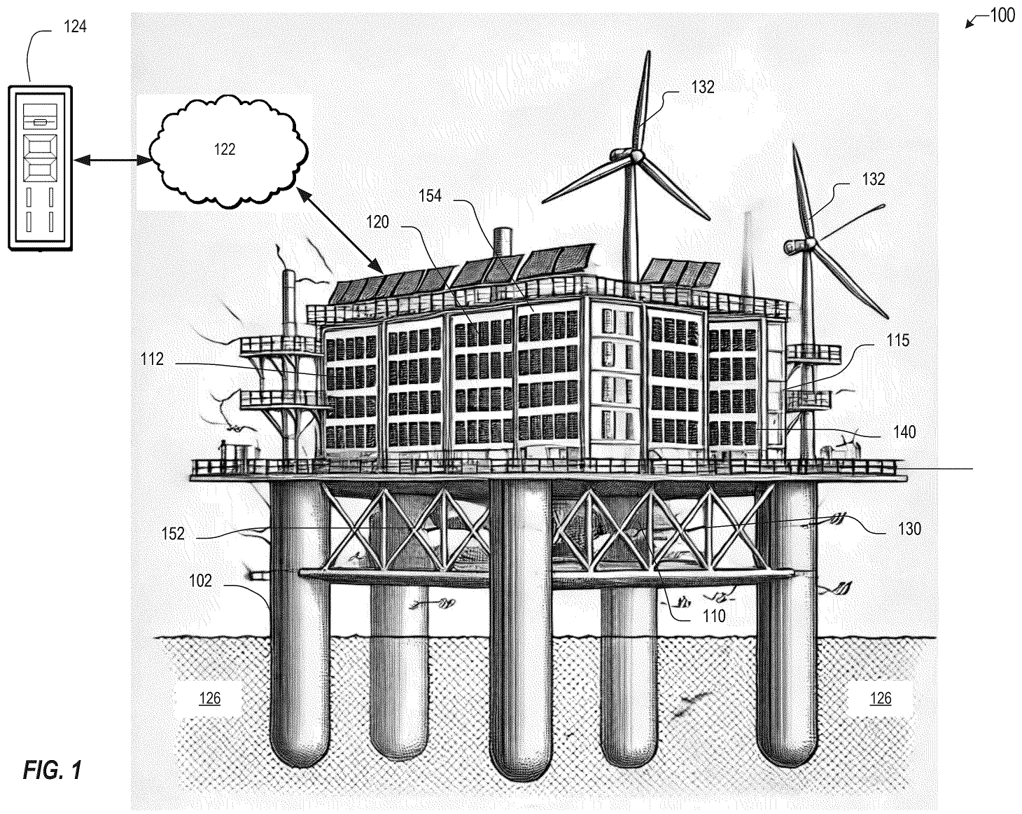

FIG. 1 illustrates a mobile semi-submerged data center platform 100 in accordance with one or more embodiments. Mobile semi-submerged data center platform 100 is configured to implement autonomous or semi-autonomous mobility, enabling the transport and deployment of a mobile nuclear-powered data center at a predetermined location. Mobile semi-submerged data center platform 100 includes infrastructure to support both nuclear power generation and data center operations. In particular, the mobile nuclear-powered data center includes improved AI and HPC infrastructure to operate as a standalone data center with enhanced security, scalability, and operational flexibility. Thus, the mobile nuclear-powered data center is capable of relocation ≥1 nautical mile without disassembly or towable within 24 hours.

In some embodiments, mobile semi-submerged data center platform 100 includes a mobile platform 102, a nuclear reactor module 110, a container 112, an onboard control subsystem 115, a data center 120, a cooling subsystem 130, and a hybrid energy storage and backup subsystem 140. For example, mobile platform 102 is a floating vessel with a large mobile flat deck 134 that is constructed to withstand the effects of harsh ocean conditions, such as waves, currents, storms, etc. For example, flat deck 134 includes a ship hull, a barge, or a heavy-duty vehicle trailer for different environments (land or sea). In particular, unlike a moored barge, a self-propelled ship may be used to reposition mobile platform 102 under its own power. A ship configuration may have the nuclear reactor deep in the hull for stability, and the data center on upper decks with more space. Likewise, mobile platform 102 is configured to implement a plurality of mobility features that allow data center 120 to relocate autonomously in response to security threats, environmental conditions, or operational requirements. For example, mobile platform 102 is generated using a double-hull structure for buoyancy and strengthened protection. In particular, mobile platform 102 is a floating vessel or barge structured to comply with maritime safety standards for nuclear-powered ships, comprising compliance with Safety of Life at Sea (SOLAS) Chapter VIII and class society rules for nuclear vessel design, such that mobile platform 102 is deployed in harbors or international waters with regulatory approval.

In some embodiments, mobile platform 102 provides a stable, large open deck space to carry container 112 that is retrofitted to house nuclear reactor module 110 and data center 120. Specifically, container 112 includes a central containment compartment 152 to house nuclear reactor module 110 and one or more containment compartments 154 adjacent to the central containment compartment to house data center 120. For example, an oil tanker is retrofitted to house data center 120, using the large volume to house reactors and servers. On land, a rail-mounted reactor data center may be retrofitted to house data center 120; thus, data center 120 may be parked on a rail siding near where needed and moved by locomotive.

In some embodiments, nuclear reactor module 110 is configured to implement a nuclear reactor assembly to generate electric power to support various components of the platform. The nuclear reactor assembly is mounted on mobile platform 102, the nuclear reactor assembly including a nuclear reactor configured to generate electric power, a containment structure enclosing the nuclear reactor for safety, and a first cooling subsystem for removing heat dissipated from the nuclear reactor. For example, the nuclear reactor is housed in the submerged central containment compartment 152 to provide a stable and zero-carbon baseload energy source for a plurality of server racks associated with data center 120. The plurality of server racks include multiple computing servers, data storage devices, and networking equipment. Mobile semi-submerged data center platform 100 implements an integrated control component that incorporates multiple AI-based energy management components and safety features to dynamically monitor and control power input and cooling for data center 120 by optimizing security and operational flexibility. The integrated control component includes a controller that is configured to execute multi-objective optimization over power mix, depth/heading, and cooling setpoints. The controller employs a digital twin that includes a reduced-order thermal-hydraulic model and a direct current (DC) power-flow model. The digital twin is configured to simulate a reactor/cooling behavior to optimize setpoints every 5-30 seconds (s) via model predictive control, with reinforcement-learning policy updates during low-risk intervals. The integrated control component selects an underwater depth of mobile platform 102 based on a multi-objective function minimizing power usage effectiveness (PUE) and reactor fuel burnup rate, subject to safety constraints including maximum hull stress and ballast tank limits. For example, the integrated control component is configured to determine that mobile platform 102 may be submerged when a PUE target is less than or equal to 1.2 and an availability rate greater than or equal to 99.5%. As another example, the integrated control component is configured to determine mobile platform 102 may be semi-submerged when a PUE target is less than or equal to 1.3. As a result, a control policy is determined by minimizing the multi-objective function that is based on a weighted sum of PUE, reactor fuel burnup variance, and predicted security risk. The control policy is used to determine a plurality of outputs setpoints for reactor power, hydrogen charge/discharge, coolant pump speed, and platform depth. Furthermore, the control policy is dynamically updated via reinforcement learning using telemetry from reactor, cooling, navigation, and IT workload sensors.

In some embodiments, data center 120 includes an onboard power distribution subsystem that is implemented to supply power to the plurality of server racks. The nuclear reactor is integrated with one or more renewable energy sources 132, such as wind, solar, wave/tidal, and hydroelectric power, to ensure continuous and resilient power delivery. As another example, onboard control subsystem 115 includes a machine learning (ML)-based integrated control component that is used to generate a model to dynamically monitor and regulate an electric power supply for data center 120 by optimizing energy consumption and cooling efficiency based on the computing demand for data center 120. Onboard control subsystem 115 is configured to measure a change in the computing demand for data center 120. In response to detecting the change, Onboard control subsystem 115 is configured to use a feedback loop to dynamically control a power level of the nuclear reactor by adjusting control rods or coolant flow in the nuclear reactor to increase/decrease electrical generation, within predetermined safe ramping rates, thereby accomplishing fine-grained load following to minimize reliance on stored energy.

In some embodiments, conventional data center platforms are mainly based on stationary, land-based brick-and-mortar data centers or submerged data centers that lack the necessary integration of nuclear power and mobility features. Furthermore, conventional data center platforms are not designed for remote operations; thus, they do not dynamically adjust energy resources to support different scalable HPC/AI workloads. Specifically, conventional data center platforms may not include scalable, AI-optimized infrastructure for HPC/AI workloads using high computational density and efficient energy management. Thus, conventional data center platforms often suffer from the problem of scalability for HPC/AI workloads. For example, conventional data center platforms include an artificial reef data center that integrates a data center into artificial reef structures with stationary cooling in the marine environment to promote marine life while housing computing equipment. The artificial reef data center that usually lacks mobility is primarily focused on environmental sustainability to promote marine life, not operational flexibility or data security. The artificial reef data center does not include a nuclear power source, thus limiting its ability to provide a stable and reliable energy source in remote locations. In another example, conventional data center platforms include a stationary data center submerged in a coolant fluid, such as dielectric fluids, to cool servers efficiently in a sealed container. The stationary data center relies on a passive heat transfer mechanism to reduce energy consumption for cooling. The stationary data center also lacks mobility and a nuclear power source that allows it to relocate to different environments. The stationary data center usually relies on external energy grids or renewable sources that are not dependable in remote or offshore environments. Furthermore, the stationary data center needs to address the issue of scalability for HPC/AI workloads for environments where computing power demand fluctuates. In another example, conventional data center platforms include a data vessel integrated with a cooling and docking station with ancillary services. The data vessel is focused on cooling and maintenance infrastructure for easy service and maintenance. However, the data vessel relies on traditional energy sources and stationary operations without integrating a nuclear power source and mobility. Furthermore, the data vessel has a docking system designed for maintenance, not for dynamic operational relocation based on real-time security or environmental factors.

In some embodiments, traditional floating data centers are installed in barges to reduce cooling costs and locate computing capacity near coastal cities. The traditional floating data centers rely on a combination of conventional grid power and local power sources from nearby power plants for reliable and sustainable operation. Conventional grids provide primary power with a primary source of electricity from fossil fuels, such as natural gas, coal, oil, etc. Local power sources, such as backup generators, renewable energy, battery storage, fuel cells, or microgrids, generate electricity locally to ensure uninterrupted service and reduce reliance on conventional grids. For example, a diesel or natural gas generator is utilized to provide a reliable power source when the main utility grid fails. As another example, renewable energy includes solar, wind, and hydro power from natural resources that are constantly replenished. However, the traditional floating data centers suffer from carbon or fuel logistics issues.

Compared to conventional data center platforms, mobile semi-submerged data center platform 100 is configured to provide reliable, high-density power and computing services in remote or power-constrained locations. Mobile semi-submerged data center platform 100 implements a renewable energy interface that allows mobile platform 102 to import or export electrical power to one or more external renewable energy sources, such as wind, solar, wave/tidal, and hydroelectric power. The renewable energy interface is configured to export electrical power to shore or third-party vessels while maintaining a reserve margin for the data center module and nuclear reactor auxiliary loads. Specifically, onboard control subsystem 115 is configured to use the renewable energy interface to dynamically balance power from the nuclear reactor and the one or more external renewable energy sources to maintain continuous power to data center 120.

In some embodiments, data center 120 implements an onboard power distribution subsystem to supply power to a plurality of computing servers. Mobile semi-submerged data center platform 100 implements an electrical interface electrically coupling the nuclear reactor assembly to the onboard power distribution subsystem of data center 120, such that the plurality of computing servers are powered at least in part by electricity generated from the nuclear reactor assembly. For example, power cabling connects a power output from a generator of the nuclear reactor to various power distribution units (PDUs) and uninterruptible power supplies (UPS) associated with data center 120 to feed the plurality of computing servers. Onboard control system 115 is configured to operate an integrated control component to monitor and regulate a real-time power level of the nuclear reactor in response to a load change of data center 120. Likewise, onboard control system 115 is configured to operate cooling subsystem 130 to dissipate heat generated from nuclear reactor module 110 and HPC hardware using seawater-based heat exchangers and dielectric fluid circulation. In a preferred embodiment, cooling subsystem 130 includes a plurality of air handlers or liquid cooling loops in a shared mode. For example, cooling subsystem 130 uses a heat exchanger network that allows excess heat from a secondary loop of the nuclear reactor to be dissipated into seawater. Likewise, cooling subsystem 130 separately implements a chilled water loop to cool the plurality of computing servers using seawater-cooled chillers. Thus, by combining nuclear reactor module 110 and data center 120, mobile semi-submerged data center platform 100 provides a self-sustained computing facility to provide reliable, high-density power and computing services in remote or power-constrained locations by achieving a compact footprint to leverage the surrounding water environment 126 for thermal management.

In some embodiments, mobile semi-submerged data center platform 100 is configured to be transported to a predetermined deployment site, such as moored offshore, docked at a port, or situated on land. For example, mobile semi-submerged data center platform 100 is self-propelled or towed by a tugboat to the predetermined destination. In particular, mobile platform 102 includes a plurality of stability features, such as ballast tanks, to stabilize the mobile semi-submerged data center platform 100 to protect sensitive IT equipment from wave motion.

In some embodiments, mobile semi-submerged data center platform 100 is configured to use a modular land transport system for land-based deployments. For example, nuclear reactor module 110 and data center 120 are contained in one or more rugged shipping containers or skids that are loaded on heavy trucks or rail, delivered to the predetermined deployment site, and quickly connected. Thus, mobile semi-submerged data center platform 100 may be relocated as needed to offer unprecedented flexibility in data center placement. Mobile semi-submerged data center platform 100 is configured to comply with maritime safety standards for nuclear vessels, satisfying the requirements of the International Maritime Organization (IMO) Nuclear Ship Code and classification societies, thereby enabling them to be licensed and insured for operation.

In some embodiments, container 112 is configured to house nuclear reactor module 110 within a robust containment that prevents the release of fission products. For example, container 112 includes a steel and concrete structure or a composite radiation-shielding vessel. Likewise, container 112 also provides biological shielding to limit radiation in the data center sections to a predetermined safe level. For example, container 112 is configured to limit radiation in data center 120 under normal operations in occupied areas to remain below background or regulatory limits. Specifically, the entire nuclear reactor module 110 is mounted on shock absorbers or isolation bearings to protect different components of mobile semi-submerged data center platform 100 from each other's vibrations and movements.

In some embodiments, data center 120 includes a plurality of modular data center modules mounted on mobile platform 102, such as modular data hall units, that include server racks, networking devices, and environmental controls. Each of the plurality of modular data center modules may be a standard International Organization for Standardization (ISO) shipping container that is converted into a server room or a purpose-built section of the ship/barge-like structure. For example, data center 120 includes a plurality of high-density computing server racks, data storage devices, and networking equipment for implementing HPC/AI workloads. The plurality of high-density computing server racks include a plurality of hot-swap compute pods that incorporate wet-mate fluid couplings rated ≥8 bar and military standard (MIL-STD) sealed power/connectors, permitting replacement under pressure without draining the secondary loop. Data center 120 includes a docking interface for removable modules, such as compute pods or reactor cartridges. The docking port includes alignment cones and load-bearing latch arms that guide the incoming module into position. Once aligned, paired wet-mate fluid couplings and sealed electrical quick-connectors automatically engage under pressure, completing both cooling and power circuits without requiring system shutdown or coolant drainage. This arrangement enables rapid replacement or upgrade of pods in a marine environment, reducing downtime compared to conventional dry couplings that require manual disassembly and re-pressurization of the cooling loop. As another example, data center 120 is equipped with liquid cooling by leveraging the ample power budget. A plurality of modular connectors and coupling mechanisms are used in data center 120 to allow the plurality of modular data center modules to be linked together electrically and/or mechanically when deployed, thereby forming a larger aggregated data center complex with increased computing and power capacity. Thus, the plurality of modular data center modules may share the HPC/AI workloads and provide backup for each other, improving overall system reliability and scalability.

In some embodiments, data center 120 is configured to implement a communication interface for data connectivity. The communication interface includes at least one high-bandwidth fiber optic link or satellite communication system, allowing data center 120 to serve remote clients or integrate into a wider network. Likewise, the communication interface is connected to a 5G wireless core network or satellite ground station placed on mobile platform 102, leveraging the abundant power and the mobility to position near users. Thus, mobile semi-submerged data center platform 100 becomes a floating edge computing node that moves along a coastline to support events or varying demand geographically. For example, data center 120 is connected to an external user server, such as user server 124, via a suitable network 122 using high-speed and low-cost wireless networking equipment, such as fiber optic connections, satellite uplinks, etc., to meet a predetermined criterion. In particular, data center 120 implements one or more environmental controls for cooling and fire suppression on the mobile semi-submerged data center platform 100. As a result, data center 120 may implement a data-center-as-a-service model in which computing resources on the mobile platform are accessible to different users via the Internet or dedicated network connections, irrespective of the platform's physical location.

In some embodiments, a service provider operates a fleet of mobile nuclear-powered data center platforms in a global “cloud at sea.” Each of the mobile nuclear-powered data center platforms is a transportable data center platform that includes a structural body adapted for transit and redeployment, the body housing both (i) a power generation section containing a nuclear reactor and associated power conversion hardware, and (ii) a data processing section containing racks of computing equipment. The nuclear reactor is a fusion reactor or an advanced fission reactor that produces minimal long-lived radioactive waste. The transportable data center platform includes a fleet coordination interface that exchanges telemetry and workload placement directives with at least one other platform to migrate virtual machines or containers between platforms based on latency, thermal capacity, and available baseload power.

In some embodiments, each of the mobile nuclear-powered data center platforms includes a respective baseload power module selected from: (i) a nuclear microreactor, (ii) a small modular reactor, or (iii) a hydrogen fuel-cell cluster with onboard electrolysis and storage; and a fleet orchestrator configured to (a) assign computer jobs to platforms based on measured end-user latency and cooling reserve and (b) command physical repositioning of at least one platform to meet a latency or thermal objective. The mobile nuclear-powered data center platforms exchange auxiliary electrical power peer-to-peer via moored direct current (DC) umbilicals while maintaining isolation of reactor safety systems. Each of the mobile nuclear-powered data center platforms includes autonomous docking hardware that mates to a service vessel to swap a sealed reactor module or compute pod, the docking hardware including alignment cones, load-bearing latches, and fluid/electrical blind-mate connectors actuated under artificial intelligence (AI) supervision.

In some embodiments, the transportable data center platform includes a plurality of modular connection points on the body for external interfaces, comprising at least one power interface for connecting to an external electrical grid or renewable energy source, and at least one data interface for connecting to telecommunications networks. The transportable data center platform includes a hybrid power management system that controls the distribution of electrical power from the power generation section to the data processing section and the external power interface, the power management system comprising control circuitry to manage power flows, energy storage utilization, and failover to backup power. The nuclear reactor in the power generation section is an inherently safe microreactor designed to have a limited emergency planning zone contained within the transportable platform, and the platform is constructed to comply with at least one national or international nuclear safety standard applicable to mobile reactors. The data processing section is configured to operate as a secure data center environment with controlled temperature, humidity, and physical security, such that the entire platform can provide data center services independently of location while meeting applicable safety, security, and liability requirements for nuclear-powered operations. The transportable data center platform includes a radiation-hardened infrastructure for the data processing section. The transportable data center platform includes electronic components and shielding that protect the computing equipment from any residual radiation or electromagnetic interference emitted by the reactor section. When a customer subscribes to computing capacity on the fleet, the service provider may choose to station the fleet in an optimal location, considering latency to users, cooling conditions, fuel logistics, etc. In the meantime, the service provider may even reposition the fleet as needed. A fleet orchestrator assigns jobs across platforms based on end-user latency and available thermal headroom, and jobs migrate via encrypted links using live-migration protocols.

In some embodiments, network 122 broadly represents any wireline or wireless network, using any of satellite or terrestrial network links, such as public or private cloud on the Internet, ad hoc networks, local area networks (LANs), metropolitan area networks (MANs), wireless LANs (WLANs), wide area networks (WANs), wireless WANs (WWANs), public switched telephone networks (PSTNs), campus networks, internetworks, cellular telephone networks, or combinations thereof. Network 122 may include or comprise the public internet and networked server computers that implement Web2 and/or Web3 technologies. Network 122 may comprise or support intranets, extranets, or virtual private networks (VPNs). Network 122 may also comprise a public switched telephone network (PSTN) using digital switches and call forwarding gear. Network 122 may also comprise a public switched telephone network (PSTN) using digital switches and call forwarding gear.

In some embodiments, the onboard power distribution subsystem of data center 120 implements a redundant architecture that includes dual power feeds from a main power source, each power feed protected by one or more UPS and backup subsystems. The one or more UPS and backup subsystems may be battery-based or rotary to continue providing electrical power to the plurality of computing servers and other electronic components in data center 120. In particular, the UPS and backup subsystems are sized to keep critical loads alive during a first moment of any power source transition. Because the nuclear reactor is dependable, the UPS and backup subsystems are used less frequently than in a diesel-powered facility. However, the one or more UPS and backup subsystems are essential for fault tolerance.

In some embodiments, the onboard power distribution subsystem of data center 120 is configured to prioritize power export over onboard IT capacity. For example, the onboard power distribution subsystem is configured to deliver 80% of the total 50 MW output from a floating nuclear plant to a coastal city's power grid. Likewise, the onboard power distribution subsystem is configured to deliver the remaining 20% output to data center 120, that manages the power distribution and provides grid-balancing services. Similarly, the onboard power distribution subsystem of data center 120 is configured to maximize onboard IT, filling every available space with servers such that data center 120 uses nearly all reactor output continuously. For example, the onboard power distribution subsystem of data center 120 is configured to apply multiple proper power splits, such as 10-50 MWe for the nuclear reactor assembly, 8-40 MWe for IT, and ≤15% for auxiliaries. This architecture is especially useful for blockchain mining or AI computation, where loads are controllable. Furthermore, the architecture allows for tailoring a power split. In a multiple-reactor setup, the architecture may dedicate a first nuclear reactor fully to IT and a second nuclear reactor to external loads or redundancy.

In some embodiments, nuclear reactor module 110 is configured to include one or more portable nuclear reactors in a nuclear reactor assembly to provide reliable and continuous low-cost power to various components of mobile semi-submerged data center platform 100. For example, the nuclear reactor assembly includes an SMR with a thermal power output between 10 MWt and 300 MWt. The SMR is designed for inherent safety through passive cooling and autonomous shutdown. Likewise, the nuclear reactor assembly uses a high-assay low-enriched uranium fuel to allow a core operation lifespan of at least 3 years between refuelings. As a result, nuclear reactor module 110 may provide a stable and constant energy output, ensuring continuous operation even in areas with limited or unstable access to external power grids.

In some embodiments, nuclear reactor module 110 has safety shielding and redundant safety components to protect against leaks and radiation exposure. For example, nuclear reactor module 110 includes a microreactor core, control rods, primary cooling loops, and a power conversion unit, such as a turbine-generator. Each nuclear reactor is coupled to a corresponding heat dissipation component to manage the thermal output during operation. The corresponding heat dissipation component implements natural seawater heat exchange and dielectric fluid cooling to ensure that the nuclear reactor core remains within optimal operating temperatures, protecting both the reactor and the data center's computing hardware. For example, nuclear reactor module 110 is coupled to different components involving on-board containment, shielding, and passive cooling, to ensure that the Emergency Planning Zone (EPZ) of nuclear reactor module 110 is minimized to within mobile semi-submerged data center platform 100 itself to facilitate port access and public safety. As another example, nuclear reactor module 110 includes an advanced microreactor in a 1-5 megawatt electric (MWe) range. As another example, nuclear reactor module 110 includes an SMR in the 1-50 MWe or 100-300 MWt range. In particular, nuclear reactor module 110 includes one or more small nuclear reactors, such as a high-temperature gas-cooled reactor or a molten salt reactor, with inherent safety (passive shutdown and decay heat removal) to eliminate the risk of meltdown, thereby simplifying regulatory approval. The one or more small nuclear reactors are installed with radiation shielding to protect personnel and sensitive electronics.

In some embodiments, nuclear reactor module 110 is configured to drive power generation equipment, such as a turbine-generator, a solid-state energy converter, etc., to produce electricity for a plurality of computing servers associated with data center 120. By using nuclear power, mobile semi-submerged data center platform 100 achieves a high availability power supply, such as a targeting capacity factor of greater than 90%, that can support 24/7 data center operation without refueling for several years. Furthermore, nuclear reactor module 110 may be refueled or swapped during scheduled outages. The compact and modular infrastructure of nuclear reactor module 110 allows multiple units to be clustered if higher capacity is needed. As a result, nuclear reactor module 110 may efficiently satisfy the growing energy demand of data centers with a zero-carbon baseload source that may be nuclear or a hydrogen/fuel-cell cluster with on-platform H₂ synthesis.

In some embodiments, nuclear reactor module 110 is configured to include a compact high-temperature gas reactor (HTGR) using tri-structural isotropic particles (TRISO) fuel that withstands very high temperatures without melting. The HTGRs are inherently safe in that loss of active cooling does not lead to core damage. For example, the HTGRs include a transportable gas-cooled reactor using high-assay low-enriched uranium (HALEU) fuel, which is suitable to provide power to data center 120 integrated in mobile semi-submerged data center platform 100.

In some embodiments, nuclear reactor module 110 is configured to include a molten salt reactor (MSR) using liquid fuel or coolant. MSRs operate at near-atmospheric pressure to avoid high-pressure risks and have passive drainage systems to stop reactions in emergency cases. A compact MSR could be an ideal choice for a marine environment since it eliminates the risk of high-pressure steam accidents, aligning with regulatory pushes to modernize maritime nuclear tech beyond PWRs. For example, a 100 MWt class molten salt reactor may be used for marine propulsion due to its intrinsic safety and long core life.

In some embodiments, nuclear reactor module 110 is configured to include a fast-spectrum microreactor using heat pipe technology or liquid metal coolant. The fast-spectrum microreactor has a compact size that is suitable to be used in a remote place. In particular, the fast-spectrum microreactor is small enough to fit in standard containers to provide a few megawatts of power. Furthermore, the fast-spectrum microreactor has a sealed core and long refueling interval (often >5-10 years) that makes it suitable for minimally manned operation.

In some embodiments, nuclear reactor module 110 is configured to include a marine-adapted pressurized water reactor (PWR) with proper safety. For example, a compact PWR includes an integral layout with all primary components in one pressure vessel and a low core power to reduce decay heat. The compact PWR may apply a hybrid cooling that uses active pumps for normal operation and an emergency core cooling subsystem (ECCS) for passive operation. Furthermore, nuclear reactor module 110 is configured to include a fusion reactor in a small fusion device, which provides the same steady power without long-lived nuclear waste.

In some embodiments, nuclear reactor module 110 is coupled to the one or more renewable energy sources 132 using a hybrid energy mechanism to enhance energy efficiency and reduce reliance on nuclear power when renewable sources are abundant. The one or more renewable energy sources 132 include wind turbines, solar panels, and hydroelectric turbines strategically placed on mobile semi-submerged data center platform 100. A conventional wind-powered computing buoy system includes a buoyant computing platform powered by renewable wind energy for power to perform computational HPC/AI workloads while floating on the ocean surface. The conventional wind-powered computing buoy system is limited by its dependence on wind energy, that is intermittent and unreliable, particularly in remote or offshore locations where weather conditions vary. Thus, the conventional wind-powered computing buoy system is suitable for relatively simple computing tasks and is not suited for HPC/AI applications requiring stable and continuous power. Furthermore, the mobility of the conventional wind-powered computing buoy system is limited to drifting with ocean currents, lacking autonomous relocation capabilities or the ability to integrate nuclear power for more stable energy output.

In some embodiments, for mobile semi-submerged data center platform 100, onboard control system 115 is implemented to dynamically allocate power between nuclear reactor module 110 and the one or more renewable sources 132 based on the real-time energy demand of data center 120, environmental conditions, and availability of renewable resources. Specifically, mobile semi-submerged data center platform 100 includes a remote monitoring subsystem that is automated to adjust a plurality of operations for nuclear reactor module 110 and data center 120. The plurality of operations are determined by using redundant sensors and control algorithms that manage reactor power levels, data center power usage, and safety interlocks without continuous human intervention. For example, when sufficient wind or solar power is available, onboard control system 115 is implemented to send a command to an operator to reduce the load on nuclear reactor module 110, improving the overall energy efficiency of mobile semi-submerged data center platform 100.

Furthermore, mobile semi-submerged data center platform 100 includes an energy storage and backup subsystem integrated with mobile platform 102. The energy storage and backup subsystem includes at least one energy storage device, such as hydrogen fuel storage with fuel cell converters, batteries, and flywheels. For example, the energy storage and backup subsystem includes an electrolysis unit configured to use surplus electrical power from the nuclear reactor to generate hydrogen, a plurality of hydrogen storage tanks for storing the generated hydrogen, and one or more hydrogen fuel cells capable of converting the stored hydrogen back into electricity, so that the energy storage and backup subsystem provides a hydrogen-based energy buffer for load leveling and emergency power, thereby reducing the need for external grid support or fossil-fuel generators. The energy storage and backup subsystem is configured to store excess electrical energy generated during periods of low computing load and to supply supplemental electrical power to data center 120 during periods of high load or the nuclear reactor shutdown. The energy storage and backup subsystem includes battery storage sized to deliver ≥30 seconds of full IT load and hydrogen storage sized to deliver ≥6 hours at ≥50% of rated IT load. For example, the onboard power distribution subsystem is configured to connect an output feeder from the onboard power distribution subsystem to an external facility and supply auxiliary power to the external facility without interrupting the electric power supply for data center 120. Thus, mobile semi-submerged data center platform 100 is characterized by the dual-use capability as both a data center and a temporary power station for local needs. As a result, the hybrid energy mechanism may make the mobile semi-submerged data center platform 100 highly adaptable to various environments, from offshore installations to deep-sea operations, where wind, solar, and water currents can be leveraged to supplement nuclear power.

In some embodiments, the energy storage and backup subsystem is configured to implement a hybrid energy variation method to store excess electrical energy using mechanical storage, such as flywheels or compressed air. Alternatively, the energy storage and backup subsystem integrates a plurality of supercapacitors to handle very short bursts of power demand from the plurality of computing servers when a large number of disks spin up at once. When an operation site has a reliable power grid, mobile semi-submerged data center platform 100 may be normally grid-connected and use the nuclear reactor assembly as a backup, effectively providing a nuclear UPS for data center 120.

In some embodiments, mobile semi-submerged data center platform 100 includes one or more safety subsystems mounted on mobile platform 102. The one or more safety subsystems include radiation shielding, a reactor shutdown system, and an emergency cooling subsystem. Furthermore, the one or more safety subsystems are configured to ensure the nuclear reactor assembly operates within safe parameters and to protect personnel and equipment, thereby enabling the mobile platform to meet nuclear regulatory requirements for transportable or maritime reactors. The one or more safety subsystems may be used to periodically perform maintenance and refueling operations for the nuclear reactor assembly on-site or at a refueling facility. For example, The one or more safety subsystems may be used in a plurality of operations involving shutting down the nuclear reactor, cooling the nuclear reactor to a safe state, either replacing the spent fuel with fresh fuel or replacing the entire nuclear reactor module, and then restarting the nuclear reactor. Such maintenance cycles are scheduled and executed with minimal disruption to the data center operations, using the energy storage subsystem to keep the servers powered during reactor downtime if maintenance is done in situ.

In some embodiments, cooling subsystem 130 is configured to be an integrated cooling subsystem that serves both reactor cooling and data center HVAC needs by taking advantage of the platform's location. Specifically, mobile semi-submerged data center platform 100 implements the integrated cooling subsystem by combining a first cooling subsystem for nuclear reactor module 110 with a second cooling subsystem for data center 120 using a common heat sink. For example, the common heat sink include a seawater loop maintaining a temperature difference AT discharge of ≤5-10 degrees Celsius (° C.) above ambient at outlet. The integrated cooling subsystem uses seawater pumps and heat exchangers to dissipate reactor waste heat and cool the data center equipment, enabling high-efficiency heat removal and eliminating the need for large cooling towers on mobile platform 102. The effectiveness of the integrated cooling subsystem may be determined using Equations 1 and 2. For example, a heater exchanger may reject 50 kilowatt (kW) of heat into the ocean when the overall heat transfer coefficient is 100 Watt per square meter per Kelvin (W/m²K), the heat flow area of the heat exchanger plate is 10 meter squared (m²), the coolant average temperature is 70° C., and the constant seawater temperature is 20° C.

$$Q = UA Δ {T}_{l m} \qquad ( 1 )$$

$$Δ {T}_{l m} \approx {T}_{c \_ avg} - {T}_{s w} \qquad ( 2 )$$

where Q is the heat flow rate, U is the overall heat transfer coefficient, A is the heat flow area of the hull exchanger plate, ΔTₗₘ is the logarithmic mean temperature difference between the coolant and seawater, T_{c_avg} is the coolant average temperature, and T_{sw} is the constant seawater temperature.

In some embodiments, cooling subsystem 130 includes a hull-integrated heat-exchanger manifold. In the hull-integrated heat-exchanger manifold, one or more cooling loops circulate secondary coolant from the reactor and IT equipment through multiple plate-frame exchangers mounted flush with the outer hull of the mobile platform. Cold seawater is drawn across the exchanger surfaces to remove waste heat. To reduce fouling by barnacles, algae, and sediment, the manifold incorporates ultrasonic transducers mounted along the exchanger plates. The transducers emit 40-60 kHz pulses to prevent biological adhesion and may be supplemented by mechanical wipers that periodically sweep the exchanger face. This integrated arrangement provides continuous high-capacity heat rejection without requiring large above-deck cooling towers, while reducing maintenance intervals compared to conventional seawater-cooled exchangers. In one embodiment, hull-mounted plate-frame heat exchangers provide ≥20 MWt of rejection at a seawater ΔT of 8° C. with a flowrate of 4,500-6,000 m³/h, maintained by dual-redundant pumps (N+1) with variable frequency drives; anti-fouling is achieved via 40-60 kilohertz (kHz) ultrasonics and periodic mechanical wipers.

In some embodiments, for a sea-based platform, cooling subsystem 130 is configured to apply seawater cooling to provide advanced cooling and heat utilization for thermal management associated with a close coupling of nuclear reactor module 110 and data center 120. For example, cooling subsystem 130 may apply direct heat exchangers when using liquid-cooled servers to directly pump cold seawater through a secondary loop to absorb heat. Thus, seawater is circulated through heat exchangers to dissipate the waste heat of nuclear reactor module 110 and cool the plurality of computing servers of data center 120, taking advantage of the ocean as an unlimited heat sink. The co-location of heat sources and sinks yields high overall efficiency. As another example, cooling subsystem 130 may use seawater-cooled chillers to apply a separate chilled water loop to cool the computing servers in data center 120. In some embodiments, the waste heat of reactor nuclear reactor module 110 or the plurality of computing servers of data center 120 is repurposed for desalination, district heating, or absorption chilling on the platform, providing additional services, such as fresh water or cooling, to nearby facilities or communities. This dual-use of thermal energy aligns with emerging concepts of nuclear-renewable hybrid systems that supply both electricity and heat for diverse applications.

In some embodiments, cooling subsystem 130 is configured to apply air cooling using large radiator fins and evaporative cooling towers when water cooling is not available in a surrounding environment, such as the desert. Likewise, a heat-pipe reactor is used in the desert to dump heat passively to the air. Data center 120 may use evaporative cooling or liquid-to-air heat exchangers.

In some embodiments, cooling subsystem 130 is configured to include a two-phase immersion cooling subsystem that is used for the servers of data center 120. Data center 120 is submerged in coolant fluid, such as a dielectric fluid, to cool servers efficiently in a sealed container. Data center 120 relies on passive heat transfer systems to reduce energy consumption for cooling. For the two-phase immersion cooling subsystem, a heat exchanger is applied to transfer the heat from the dielectric fluid to seawater. As a result, the nuclear reactor may operate at much higher temperatures than the servers tolerate. Thus, there are two separate cooling loops. A first cooling loop is for the reactor core of the reactor. The reactor core might be around 650° C. in a high-temperature reactor, cooled by helium or salt. A second cooling loop is for data center 120 that needs cooling water at perhaps 15° C. supply. The reactor's waste heat ultimately goes to the sea. Some low-grade heat from turbine exhaust or generator coolant at −80° C. may be used to drive an absorption chiller to aid in cooling the data center without electrical chillers, improving efficiency.

In some embodiments, onboard control system 115 is configured to operate the nuclear reactor using triple-redundant controllers. Specifically, the nuclear reactor is monitored remotely via satellite or fiber-optic link. In a normal steady-state, the nuclear reactor supplies a constant power output tuned to a baseline load of data center 120. For example, when data center 120 draws around 10 MW on average, onboard control system 115 is configured to send a first operation to set the reactor to produce around that amount. Likewise, onboard control system 115 may load-follow to an extent. For example, when the IT load of data center 120 drops at night, onboard control system 115 is configured to send a second operation to trim down the reactor power and direct excess electricity to hydrogen production. As another example, when the IT load of data center 120 surges beyond a predetermined reactor capacity threshold, onboard control system 115 is configured to send a third operation to draw on stored energy or briefly ramp up the reactor within a predetermined margin. Many microreactors have near-instantaneous load-following capabilities, especially those using heat pipes or advanced coolants, unlike conventional large nuclear plants. This flexibility is critical for data center use, where power demand can fluctuate with server workload or when servers are taken offline/online.

In some embodiments, mobile semi-submerged data center platform 100 is equipped with one or more mobility systems that allow the platform to relocate autonomously to adjust its position in response to security concerns, environmental conditions, or operational demands. The one or more mobility systems may be operated under human control, thus, a user may monitor and supervise various autonomous functions of mobile semi-submerged data center platform 100. If necessary, the user may intervene to take onboard or remote control over mobile platform 102. Likewise, the user may be an onboard operator or an operator from a shore-based control center. For example, the one or more mobility systems include an autonomous navigation system that allows it to relocate without human intervention. The autonomous navigation system uses sensors, environmental data, and real-time analysis to make AI-based decisions about when and where to move. When a security threat or an adverse environmental condition is identified, the autonomous navigation system autonomously repositions mobile platform 102 to a safer location, ensuring operational continuity and data protection.

In some embodiments, as another example, the one or more mobility systems include a manual navigation system to manually navigate or adjust the platform's position by an onboard crew in a human-accessible control room of mobile platform 102. The manual navigation system is useful in complex mission profiles where human decision-making is critical. As another example, the one or more mobility systems include a remote navigation system that is used by a human operator from a land-based or offshore location. Thus, the human operator may control the platform's movement via a secure communication link. The remote navigation system allows operators to override the autonomous navigation system if needed or take direct control based on real-time data received from the platform.

In some embodiments, the one or more mobility systems include a plurality of propulsion units, such as electric thrusters or propellers, that are activated based on a selected control mode, including autonomous mode, human-operated mode, and remote mode. The plurality of propulsion units are configured to operate efficiently in various water conditions, including shallow coastal areas or deep-sea environments. As a result, mobile semi-submerged data center platform 100 provides an enhanced mobile platform for a self-contained computing facility powered by a combination of an onboard nuclear reactor and the one or more renewable energy sources that are suitable to support HPC/AI applications. Mobile semi-submerged data center platform 100 may be human-operated or remotely controlled by an external network, such as user server 124, to facilitate relocation and efficient deployment in various locations, including remote or sensitive environments. Because mobile semi-submerged data center platform 100 is ocean-worthy for transportation, data center 120 may be transported to a predetermined deployment site or relocated as needed to provide secure, energy-efficient, and flexible high-capacity computing systems capable of operating in remote and sensitive environments.

In some embodiments, the mobile platform of mobile semi-submerged data center platform 100 remains fully above the water surface. This free-floating structure is configured to house all components, including a nuclear power generation module, one or more renewable energy sources, and one or more cooling subsystems on the surface of the water. The mobile platform is equipped with a buoyancy control mechanism that remains stable on the water's surface. For example, the buoyancy control mechanism utilizes a plurality of ballast tanks and other buoyancy devices to regulate the position of the mobile platform, enabling it to float and move freely while anchored or in motion. The mobile platform includes ballast-driven depth modulation that is implemented to control the operating depth of mobile semi-submerged data center platform 100 by adjusting the amount of ballast. Depth is adjusted in 1-5 m increments via ballast control with <3 min response. The heading is trimmed to align the cross-flow with the exchanger banks, increasing convective coefficients during high-load events. For example, the mobile platform is configured to dive/surface in a depth step of 0-100 m with a response time of 10 s. As another example, the mobile platform is configured to adjust trim ballast for depth trimming in a depth step of 0-2 m with a response time of 5 s. In particular, the mobile platform is configured to operate with autonomous navigation, remote control, or human-operated navigation.

Furthermore, the mobile nuclear-powered data center platform may include a nuclear power assembly that is housed in a shielded compartment located above the waterline. The nuclear power assembly continues to generate power for the data center, but with cooling subsystems adapted for air and water cooling. Likewise, the mobile nuclear-powered data center platform incorporates one or more renewable sources, such as wind turbines, solar panels, and wave/tidal generators installed on the floating structure to supplement power from the nuclear reactor assembly.

Furthermore, the mobile nuclear-powered data center platform includes one or more air-based cooling subsystems and seawater-based cooling subsystems, such as heat radiators along with seawater heat exchangers. Thus, a dielectric fluid may still be used to circulate within the vessel, cooling electronic components, with excess heat dissipated into the surrounding air or water. The mobile nuclear-powered data center platform includes one or more propulsion mechanisms, such as electric thrusters, that allow the mobile platform to relocate as needed. Mobile semi-submerged data center platform includes one or more intrusion detection systems, such as perimeter monitoring and environmental sensors to detect threats, such as intrusions or natural hazards, ensuring that even on the surface, security remains a priority.

In some embodiments, the mobile nuclear-powered data center platform is configured to operate while fully connected to the shore via cables for both power and data transmission. The shore-connected data center has an advantage in that it allows the system to leverage both offshore nuclear power and renewable energy sources for operation, while maintaining connectivity with onshore power grids and data networks. For example, the data center is connected to the shore via underwater or above-water power cables that transmit energy from the nuclear reactor and renewable energy sources on the mobile platform to onshore facilities, and vice versa. Data cables also link the data center to land-based data networks, allowing for high-speed data transmission to and from the mobile platform. For example, a user activates a communication link from the mobile nuclear-powered data center platform to a land-based network hub, transferring data from the mobile nuclear-powered data center platform to the user. The shore-connect data center ensures continuous data flow for computing tasks that require integration with onshore infrastructure. While the nuclear reactor continues to provide the primary power source, the connection to onshore grids allows for energy redundancy, ensuring a stable energy supply even if the offshore systems experience temporary disruptions. The dynamic energy management system optimizes the allocation of power from nuclear, renewable, and grid sources, ensuring operational efficiency. The mobile nuclear-powered data center platform includes a cooling subsystem that continues to use seawater heat exchangers to manage thermal output. However, the connection to shore-based facilities allows for additional cooling infrastructure, such as onshore cooling towers, to supplement an offshore cooling subsystem when needed. The mobile nuclear-powered data center platform includes one or more intrusion detection systems and environmental monitoring systems to detect any unauthorized access or environmental hazards that may affect the cables or the mobile platform itself. The shore-connected embodiment benefits from additional security monitoring via onshore facilities, enhancing the overall safety of the whole system.

In some embodiments, the mobile nuclear-powered data center platform is configured to operate an offshore edge hub deployed in international waters just outside the territorial sea of a city, such as a dense city harbor of island nations or city-states that may not host large power plants on land, with high data demand but constrained land resources. The mobile nuclear-powered data center platform connects via undersea fiber optic cable to the city's network hub. Thus, the mobile nuclear-powered data center platform may provide cloud services to the surrounding region. Being in international waters may simplify some regulatory issues. No single nation's nuclear licensing is needed, although it is still under the flag state's regulations. However, the operator of the mobile nuclear-powered data center platform may coordinate with nearby coastal authorities for emergency response plans. The nuclear reactor operates continuously, and the mobile nuclear-powered data center platform may be relocated in response to geopolitical or weather conditions.

In some embodiments, the mobile nuclear-powered data center platform is configured to provide a port-based augmentation. For example, the mobile nuclear-powered data center platform is moored at an existing port and plugged into the grid as well as local fiber. Thus, the platform may feed both its internal data center and export surplus power to shore, helping the local grid. The data center may serve as a dedicated cloud region for a user. Because the mobile nuclear-powered data center platform is within a country's territory, the mobile nuclear-powered data center platform may go through that country's nuclear regulatory approval.

In some embodiments, the mobile nuclear-powered data center platform is configured to conduct remote operations for a remote location, such as a remote mining site in the Arctic or a disaster-relief operation in a remote area. An operator transports the mobile nuclear-powered data center platform that includes a nuclear reactor assembly and a data center module to a first location. The reactor assembly includes a nuclear reactor configured to generate electric power to meet a predetermined criterion. The operator moors or installs the mobile nuclear-powered data center platform at the first location and initiates the nuclear reactor assembly to generate electric power in a power supply for a plurality of computing servers associated with the data center module. The operator modulates the platform depth to track a thermocline identified by onboard temperature profiling, thereby reducing chiller compressor runtime and improving PUE during seasonal warm-water conditions. The mobile nuclear-powered data center platform is configured to use an electrical interface to electrically couple the nuclear reactor assembly to the onboard power distribution subsystem of the data center module to power the plurality of computing servers associated with the data center module at least in part by the electric power generated by the nuclear reactor assembly. The mobile nuclear-powered data center platform is configured to use an integrated control component to receive a computing demand for the data center module from a user. In particular, the mobile nuclear-powered data center platform includes a variable-depth control subsystem that adjusts draft or submergence depth in response to a control signal from the integrated control component to increase a temperature gradient across hull-mounted heat exchangers when ambient seawater temperature rises.

In some embodiments, the mobile nuclear-powered data center platform is configured to use the integrated control component to monitor and regulate the electric power supply based on the computing demand. The integrated control component includes a digital twin executing a thermal-hydraulic and power-flow simulation of the reactor, cooling network, and IT load. The real-time setpoints for pump speed, valve position, and platform depth are derived from the digital twin's predictive outputs. Thus, the digital twin is implemented to predict a cooling capacity shortfall greater than a predetermined time period in advance and pre-emptively (i) shifting non-critical computer tasks and (ii) initiating hydrogen-fuel-cell peaking power to avoid reactor load-following beyond a predefined ramp rate.

In some embodiments, the mobile nuclear-powered data center platform is configured to use one or more safety subsystems to implement a plurality of safety and security protocols during an operation of the mobile nuclear-powered data center platform. The operation includes continuous cooling of the nuclear reactor, radiation monitoring, and the capability to reactor protection system actuation (SCRAM) the nuclear reactor in case of emergency, and maintaining secure network communication for the data center module. The mobile nuclear-powered data center platform is configured to utilize the integrated control system to direct excess power to an energy storage and backup subsystem when computing demand is lower than the current power output from the nuclear power module. The mobile nuclear-powered data center platform is configured to use the integrated control system to direct supplemental power from the energy storage and backup subsystem or by adjusting current power output from the nuclear power module.

In some embodiments, the mobile nuclear-powered data center platform is configured to use the integrated control system to receive a command to transport the mobile nuclear-powered data center platform to a second location. Receiving the command to relocate includes autonomous threat avoidance that includes ingesting Automatic Identification System (AIS)/radar contacts and weather data, computing a risk score, and selecting a route that maintains communications under a Service Level Agreement (SLA) while keeping the EPZ offshore. Upon receiving the command, the operator relocates the mobile nuclear-powered data center platform from the first location to the second location by implementing a plurality of steps comprising ceasing data operations, shutting down the nuclear reactor to a safe transport state, and moving the mobile nuclear-powered data center platform. The first and second locations include a port or coastal site within a country, an offshore position in international waters, and a remote land site lacking grid infrastructure. For example, the safe transport state includes a plurality of conditions, such as a reactor outlet temperature, a decay heat percentage of the nominal value, containment valves A/B closed, and the EPZ contained within a specified depth. Thus, the mobile nuclear-powered data center platform provides microgrid capability to power a data center that processes geological data or coordinates relief efforts on-site, possibly also shares the generated power by supplying electricity to surrounding facilities, such as camp and equipment, with any excess power. After the mission or mine is done, the unit is removed, leaving little to no infrastructure behind to reduce environmental impact.

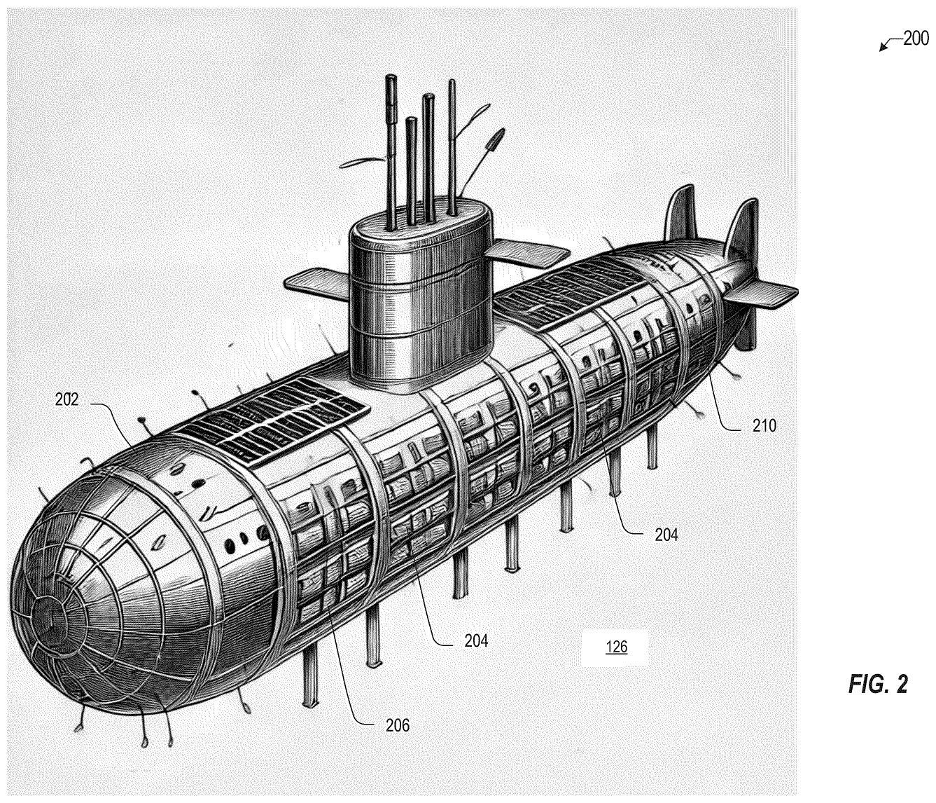

FIG. 2 illustrates a mobile submerged data center platform 200 in accordance with one or more embodiments. Mobile submerged data center platform 200 is configured to house a plurality of data servers 206 that are powered by a primary energy source 210 that includes one or more nuclear reactors located in a plurality of submerged and shielded compartments. In some embodiments, conventional submerged data center systems are usually stationary. For example, a conventional submerged data center system is towed to a deployment site, moored to anchors on the ocean floor, and connected to a proper power generating system. Thus, the vessel of the conventional submerged data center system may surface or be submerged to a recommended operating depth using variable ballast. However, the conventional submerged data center system is not suitable for dynamic relocation in response to environmental conditions or security threats. Furthermore, conventional submerged data center systems are not usually powered by a nuclear power source. The lack of scalability in power resources hinders their ability to support the growing demand for HPC/AI applications. Thus, conventional submerged data center systems find it difficult to achieve energy independence. In particular, conventional submerged data center systems have difficulty operating in remote locations with inconsistent renewable energy sources.

In some embodiments, mobile submerged data center platform 200 is configured to integrate a submarine vessel 202 with the primary energy source 210 that provides stable, continuous power regardless of geographic location or environmental factors. For example, submarine vessel 202 is a long-range high-endurance submarine that may be operated on to surface or be submerged while still allowing air exchange and service crew access to the vessel's interior. Submarine vessel 202 provides mobility to enable it to autonomously or remotely relocate, enhancing operational flexibility and security. As another example, mobile submerged data center platform 200 integrates an AI-based energy and cooling management component into the platform to ensure efficient power distribution and cooling optimization tailored to HPC/AI requirements. As another example, submarine vessel 202 includes a plurality of data center modules 204 that allow for improving the scalability of data center equipment, including cooling, power, and protection. In particular, each data center module 204 includes hot-swappable compute pods coupled via wet-mate fluid couplings and sealed electrical quick-disconnects that permit removal and insertion under pressure without draining the secondary coolant loop. Likewise, each data center module 204 implements EMP/EMI hardening, including shielded enclosures around the data center module and surge-suppression on reactor instrumentation and control buses, and a fail-secure dark-mode that physically isolates external network links while maintaining internal computer and safety functions. Such a modular design allows for seamless scaling of both nuclear power and computing components, making it adaptable to HPC workloads. Furthermore, the modular design allows for easy expansion or reduction of capabilities. As needs grow, additional nuclear reactors, renewable energy units, or computing components may be added to the platform. For example, a plurality of transportable data center platforms are aggregated to form a distributed cloud network, each platform located in a corresponding geographic region (on land or sea) and interconnected via high-speed data links, such that they collectively provide a resilient, load-balanced cloud computing service. This network of nuclear-powered platforms may dynamically share workloads and migrate virtual servers between platforms, leveraging the ability of each platform to relocate if needed to balance load or respond to regional demand spikes. Each platform in the network can be added, removed, or moved without collapsing the overall service, illustrating a flexible scalability of the data center capacity. This flexibility ensures that the platform may be scaled to meet increased computational demands or downsized for more localized applications. As a result, mobile submerged data center platform 200 may achieve energy independence by using the combination of nuclear power and renewable energy, even in remote areas where coolant systems may not have stable power supplies.

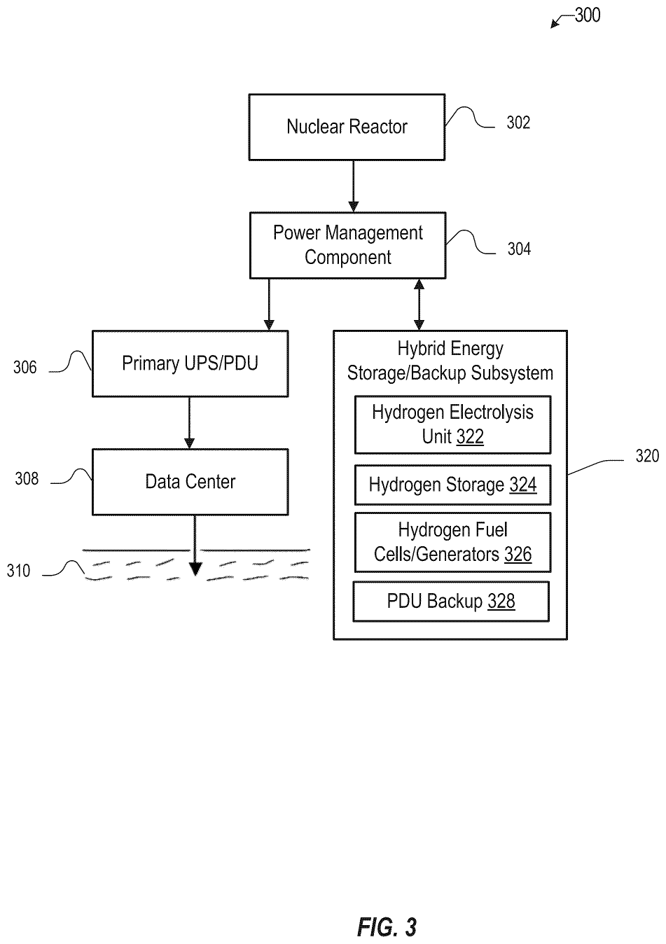

FIG. 3 illustrates a data center power topology 300 of a mobile nuclear-powered data center platform in accordance with one or more embodiments. Data center power topology 300 shows a modular, hybrid energy system that includes a nuclear reactor 302, a power management component 304, a primary UPS/PDU 306, a data center 308, cooling subsystem 310, and a hybrid energy storage/backup subsystem 320. For example, nuclear reactor 302 includes a small nuclear reactor, such as an advanced microreactor or an SMR, in the 1-50 MWe range at the core of the modular, in a hybrid energy system to act as a primary energy source for a mobile nuclear-powered data center platform. Specifically, nuclear reactor 302 includes a high-temperature gas-cooled reactor or molten salt reactor with inherent safety (passive shutdown and decay heat removal) to eliminate the risk of meltdown, thereby simplifying regulatory approval.

In some embodiments, nuclear reactor 302 is housed in a submerged and shielded compartment to generate a stable and constant energy output even in areas with limited or unstable access to external power grids. Thus, nuclear reactor 302 is configured to withstand maritime hazards (storms, collisions) and to prevent any release of radioactive material in extreme events. Nuclear reactor 302 also implements one or more advanced safety shielding and redundant safety policies against leaks and radiation exposures. For example, passive safety subsystems, such as a natural convection cooling subsystem and a gravity-fed shutdown subsystem, ensure nuclear reactor 302 remains safe without active intervention. In particular, nuclear reactor 302 is implemented to drive power generation equipment, such as turbine-generator and solid-state energy converter, to produce electricity for a plurality of computing servers of data center 308. Thus, nuclear reactor 302 acts as a stable zero-carbon baseload power source to generate a high availability power supply, such as a targeting >90% capacity factor, that supports different data center operations without refueling for several years. Furthermore, cybersecurity and physical security measures protect the data center and reactor controls from intrusion or misuse. As a result, data center power topology 300 may channel the nuclear liability to an operator of the platform in line with international conventions. The mobile nuclear-powered data center platform is insurable for commercial use by using modern reactors that avoid the pitfalls of earlier naval units. For instance, by employing a low-pressure reactor system, the mobile nuclear-powered data center platform sidesteps the historical insurance barriers associated with high-pressure reactors and thus may be brought into ports under a new regulatory paradigm.

In some embodiments, nuclear reactor 302 uses low-enriched uranium fuel, such as HALEU, or another suitable fissile material. The fuel is chosen for long core life. For example, a TRISO fuel may be used for several effective full-power years without refueling. Thus, the mobile nuclear-powered data center platform is delivered from the factory with a full fuel load. Refueling or replacement of the reactor core is done at multi-year intervals, such as every 5-10 years, depending on the design and usage. The platform may be towed to a predetermined refueling facility, or the nuclear reactor is swapped using a swappable cartridge. By avoiding frequent refueling, operational disruption is minimized, and sensitive sites do not need to handle fresh or spent nuclear fuel frequently. The platform includes secure storage for a limited amount of spent fuel if needed, or preferably, the spent fuel is removed entirely during refuel and transported to a long-term storage or recycling facility.

In some embodiments, power management component 304 is applied to prioritize real-time load handling to route power from nuclear reactor 302 or backup sources, such as hydrogen fuel cells or generators 326, shore power, renewables, etc., based on availability and demand. Power management component 304 also manages the charging of energy storage and activation of hydrogen-based failover. Thus, power management component 304 implements primary UPS/PDU 306 to direct the output of nuclear reactor 302 to feed a plurality of servers in data center 308.

In some embodiments, data center 308 includes dual power feeds, such as nuclear reactor 302 and hydrogen electrolysis units 322, from the main power source. Each power feed is backed by a corresponding UPS system. The UPS system may be battery-based or rotary, and it is sized to keep critical loads alive during the first moments of any power source transition. Because nuclear reactor 302 is very dependable, the UPS and backup systems may be used less in a diesel-backed facility, but they remain essential for fault tolerance.

In some embodiments, cooling subsystem 310 is configured to implement effective cooling by using a combination of seawater-based heat exchangers and dielectric fluid cooling subsystems. In particular, biofouling mitigation is applied on the seawater-wetted heat-exchange surfaces. The mitigation includes at least one of ultrasonic transducers, periodic mechanical wipers, or timed chlorination pulses, the integrated control component scheduling mitigation cycles based on measured heat-transfer degradation. Cooling subsystem 310 takes advantage of the ocean as an unlimited heat sink and the co-location of heat sources and sinks to yield high overall efficiency. In some embodiments, cooling subsystem 310 implements one or more seawater heat exchangers to draw cold seawater through intake pipes and circulate it around nuclear reactor 302 and various computing compartments of data center 308 to absorb the dissipated heat. The heated water is then released back into the sea, dissipating heat into the surrounding environment. Discharge temperature rise is limited to ≤5° C. at ≤10 m from the outlet, measured by onboard sensors. Upon exceedance prediction, the controller derates IT load and increases depth to access colder water. The one or more seawater heat exchangers operate continuously without mechanical refrigeration, making cooling subsystem 310 energy efficient and dependable even during extended operations.

In some embodiments, cooling subsystem 310 implements dielectric fluid inside nuclear reactor 302 and data center 308 to provide direct liquid cooling to different critical components in the platform. Dielectric fluid has a high heat capacity and is electrically non-conductive, ensuring that sensitive electronic components are protected from overheating while maintaining operational integrity. The dielectric fluid is circulated through nuclear reactor 302 and computing servers of data center 308, absorbing heat and transferring it to the seawater heat exchanger for dissipation. Thus, cooling subsystem 310 is critical to the safe and efficient operation of both nuclear reactor 302 and the high-performance computing hardware within data center 308 by ensuring that both nuclear reactor 302 and the high-performance computing servers in data center 308 remain within optimal temperature ranges, even under heavy workloads.

In some embodiments, power management component 304 applies a hybrid energy storage and backup subsystem 320 that is integrated with nuclear reactor 302 to ensure continuous and resilient power delivery. In an exemplary embodiment, the hybrid energy storage and backup subsystem 320 includes electrolysis unit 322, hydrogen storage 324, hydrogen fuel cells or generators 326, and PDU backup component 328. Electrolysis unit 322 produces hydrogen (H₂) and oxygen from water using excess electrical power. Hydrogen storage 324 includes high-pressure tanks or metal hydride storage designed with marine safety standards for the generated hydrogen. In particular, hydrogen storage 324 may be located on deck or in ventilated compartments to avoid the buildup of any leaked hydrogen. Furthermore, hydrogen fuel cells or generators 326 convert stored hydrogen back to electricity on demand. Thus, the entire cycle functions of hybrid energy storage/backup subsystem 320 work as an energy buffer.

In some embodiments, excess reactor output of nuclear reactor 302 during a low IT load period is used to produce hydrogen via electrolysis in the plurality of hydrogen electrolysis units 322, that is stored on board in tanks of hydrogen storage 324. The stored hydrogen may then feed fuel cells or generator 326 and PDU backup component 328 to provide peaking power or backup power for data center 308 when the IT load spikes or during reactor maintenance. For example, when a power output of nuclear reactor 302 exceeds current needs of the computing servers of data center 308 during scheduled low-utilization periods or if some server racks are offline, rather than throttling down nuclear reactor 302 that may not be optimal for reactor operation, that surplus electricity is fed into the electrolysis unit 322 to generate hydrogen. The generated hydrogen is safely stored in tanks of hydrogen storage 324 for at least 6-24 hours at 5 MWe. As another example, when the data center demands spike above a predetermined threshold of nuclear reactor 302, such as during a large computer job or if additional servers are brought online suddenly, hydrogen fuel cells kick in to supply the additional power with zero emissions. Fuel cells can ramp up quickly, providing peak power. The byproduct of this process is water that may be fed back into electrolysis unit 322, forming a closed loop aside from any make-up water needed.

In some embodiments, by combining steady nuclear baseload with hydrogen energy storage, data center 308 may use a hybrid approach to handle variable demand without drawing from an external grid, effectively shaving peak loads and improving overall efficiency. Data center power topology 300 may also integrate one or more renewable energy sources as external power input. For example, when deployed near an offshore wind farm or solar array, data center power topology 300 is configured to intake power from a plurality of wind turbines and throttle down reactor output or produce hydrogen with the surplus. The hybrid approach ensures 100% uptime power while optimizing fuel efficiency and sustainability. As another example, when the wind farm is grid-connected and the grid is down, nuclear reactor 302 may provide guaranteed power when wind or solar falter. Any excess renewable energy may be stored as hydrogen or used for ancillary services. Likewise, nuclear reactor 302 may even export power to the grid or other ships as an additional function that is subject to regulatory approval as a power plant. In particular, data center power topology 300 is adaptable as part of a larger energy ecosystem, that is crucial in markets like Europe where regulatory regimes favor multi-source microgrids and in remote areas where renewables are abundant but intermittent. Thus, data center power topology 300 provides a resilient microgrid within the platform, capable of islanded operation or grid connection as needed.

In some embodiments, hydrogen energy storage/backup subsystem 320 functionally becomes a stationary energy storage, analogous to a battery but using hydrogen as the medium. Hydrogen energy storage/backup subsystem 320 may also serve as an emergency backup to keep critical IT load running if nuclear reactor 302 has to scram or shut down for any reason. For example, when nuclear reactor 302 trips, the UPS and battery systems in data center 308 cover the first few seconds, then the hydrogen fuel cells ramp up to full power to carry data center 308 for as long as needed, limited by hydrogen fuel reserves that may be sized to a certain number of hours or days of autonomy. Unlike diesel generators commonly used for a typical data center, hydrogen fuel cells have the advantage of no carbon emissions and quieter operation, and if the hydrogen is produced with nuclear power, the entire chain remains carbon-free.

In some embodiments, battery banks, such as lithium-ion or flow batteries, are installed in PDU backup 328 to provide short-term or high-response power smoothing. In particular, PDU backup 328 may include a flywheel UPS for very fast response to load changes. These components are all part of the power management system 304 that orchestrates power flow between nuclear reactor 302, hybrid energy storage/backup system 320, and the workloads of data center 308.

In some embodiments, data center power topology 300 shows that the mobile nuclear-powered data center platform is sealed and climate-controlled. Especially in marine environments, data center 308 may be kept at appropriate humidity and filtered to prevent salt corrosion of electronics. The mobile nuclear-powered data center platform operates in a wide range of climates from tropical to arctic. The operation of nuclear reactor 302 is easier in a cold ocean than a warm one, but even tropical seas are effective for cooling, given a sufficient flow rate. For cold climates, the waste heat is plentiful to keep equipment warm. For hot climates, the mobile nuclear-powered data center platform ensures adequate cooling capacity.

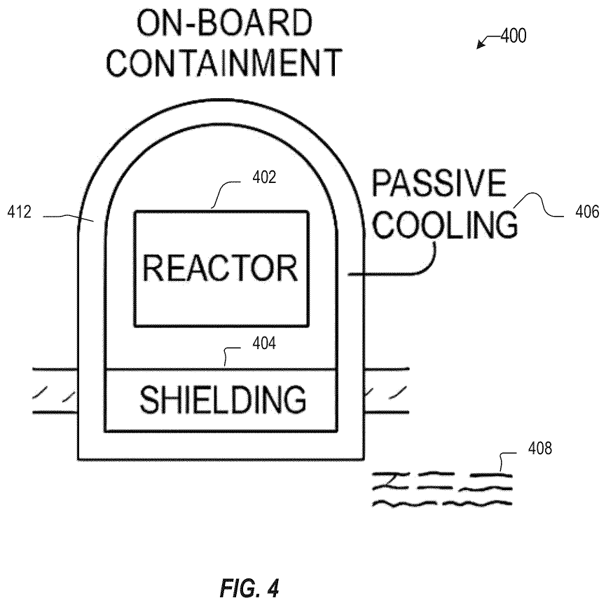

FIG. 4 illustrates a diagram 400 of key safety and regulatory compliance features in accordance with one or more embodiments. Onboard control system 115 (referring to FIG. 1) includes a plurality of core safety features to ensure secure and safe operations. The plurality of core safety features include an onboard containment 412, a structural shield 404, a passive cooling module 406, and an autonomous emergency shutdown module. Onboard containment 412 is a double-walled steel-and-concrete containment unit to provide radiation shielding to confine radiation for a nuclear reactor 402. Onboard containment 412 is strong enough to withstand internal pressures and external impacts, such as a ship collision. Furthermore, all personnel areas and data center modules have additional shielding or are located a sufficient distance from the nuclear reactor to keep radiation as low as reasonably achievable. The goal of the key safety and regulatory compliance features is that a person standing on the deck of the mobile nuclear-powered data center platform may receive a negligible radiation dose during normal operation, making it safe to board for maintenance or inspection. In case of any anomaly, the nuclear reactor may be scrammed and containment sealed; any venting in extreme scenarios may go through filters. These measures align with the Code of Safety for Nuclear Merchant Ships in requiring robust protection of the crew and environment. Thus, onboard containment 412 prevents ejection of fission products and ensures containment integrity even during submersion or impact.

In some embodiments, structural shielding 404 includes multiple-layered concrete composites and high-density polyethylene blocks to attenuate neutron and gamma radiation. All shielding complies with Nuclear Regulatory Commission (NRC) maritime reactor standards, as outlined in Title 10 of the Code of Federal Regulations (10 CFR) under Part 50. In some embodiments, in the event of a power failure, a passive cooling module is implemented to utilize a gravity-fed seawater 408 loop with phase-change cooling tanks and redundant valves, ensuring passive heat removal from the reactor without requiring pumps or power. Furthermore, the autonomous emergency shutdown module includes a failsafe reactor protection system actuation (SCRAM) capabilities and thermal trip logic to passively shut down the reactor if predefined thermal or seismic thresholds are crossed.

Additionally, onboard control system 115 (referring to FIG. 1) is coupled with a plurality of leak detection sensors to monitor for potential coolant leaks, pressure changes, and radiation levels. In the event of a detected anomaly, onboard control system 115 (referring to FIG. 1) initiates an automatic containment operation to prevent hazardous situations. For example, when a coolant leak is detected, onboard control system 115 (referring to FIG. 1) may immediately isolate the affected area and activate backup cooling subsystems to maintain safe operating conditions. Likewise, onboard control system 115 (referring to FIG. 1) is coupled with a plurality of radiation sensors to ensure that any excessive radiation levels are addressed promptly, either by adjusting reactor operation or by initiating emergency shutdown protocols. Similarly, onboard control system 115 (referring to FIG. 1) is coupled with a plurality of intrusion detection sensors to detect physical threats, such as underwater intrusions, and takes defensive measures such as ceasing network operations or failing over to redundant systems.

In some embodiments, the key safety and regulatory compliance features are critical to ensure the mobile nuclear-powered data center platform is a highly adaptable, secure, and energy-efficient solution for industries requiring advanced computing power in remote or sensitive environments. With its nuclear and renewable energy integration, modular scalability, and AI-optimized infrastructure, the platform provides a versatile and resilient infrastructure capable of supporting HPC/AI applications while maintaining the highest standards of safety and operational flexibility.

In some embodiments, the key safety and regulatory compliance features include a passive safety feature. Specifically, the nuclear reactor is to safely shut down and remove decay heat without external power or human intervention. For example, an HTGR microreactor's fuel may handle full decay heat without melting, and the core simply cools by radiating heat through the containment in worst-case scenarios. This eliminates the need for large emergency power generators or pumps, simplifying the platform and reducing points of failure.

In some embodiments, the key safety, regularization, and compliance features include that an operator of the mobile nuclear-powered data center platform is identified as the liable entity for any nuclear incident, consistent with nuclear liability principles. This is important as many international conventions channel liability exclusively to the operator of a nuclear installation. Thus, the reactor operator is the sole responsible party. The key safety, regularization, and compliance features are updated when a new maritime nuclear liability convention is adopted. Insurance may be sought via specialized nuclear insurers or pools with high safety standards to reassure insurers and regulators. For example, American Bureau of Shipping (ABS) has issued guides for nuclear power onboard vessels, and the mobile nuclear-powered data center platform is intended to comply with such class rules to obtain certification. The mobile nuclear-powered data center platform may sail under a flag state that approves its reactor (likely the state of the operator's registration or a state with which agreements are in place for nuclear vessel operation), and port states would be engaged via bilateral agreements or under IMO guidelines to permit entry.

In some embodiments, the key safety, regularization, and compliance features include export controls and security. For example, the data center may employ encryption and other standard IT security. As another example, the mobile nuclear-powered data center platform may utilize purely civilian reactor designs that are distinct from naval propulsion reactors to facilitate export under civil nuclear cooperation agreements. Furthermore, physical security against sabotage or theft is implemented. The nuclear fuel is difficult to access in sealed core modules; armed security or naval escort may be used when transiting sensitive areas, and the mobile nuclear-powered data center platform may include intrusion detection, etc.

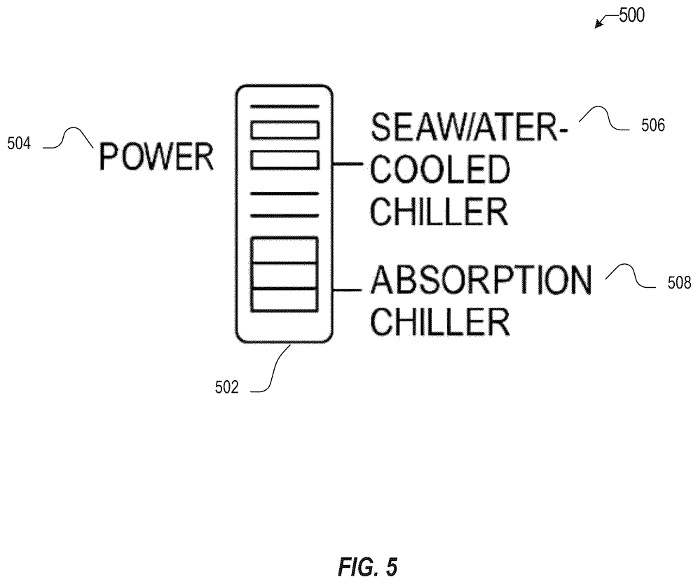

FIG. 5 illustrates an information technology (IT) infrastructure 500 by reactor class and rack configuration in accordance with one or more embodiments. IT infrastructure 500 includes a server rack 502, a power distribution 504, a seawater-cooled chiller 506, and an absorption chiller 508. Server rack 502 includes a plurality of computing servers for implementing HPC/AI workloads from various applications, such as scientific research projects, financial services, and military applications. Power management component 304 (referring to FIG. 3) is configured to generate a power distribution that connects a plurality of PDUs to server rack 502 to provide an alternating current (AC) for each rack. Likewise, Power management component 304 (referring to FIG. 3) is configured to modify power distribution to operate redundant buses to support failover via hydrogen fuel cells. Seawater-cooled chiller 506 is used in cooling subsystem 130 (referring to FIG. 1) to exchange heat with deep ocean water when warm water from hot aisles passes through the seawater-cooled chiller 506. Absorption chiller 508 driven by residual thermal energy from the reactor or fuel cells is used to offset electrical cooling loads during peak heat or power constraints.

In some embodiments, each nuclear reactor is configured to scale with the number of computing servers in server rack 502, load density, and mission duration. The barge is configured to house up to three modular reactors in series or hybrid micro/MSR configurations. An AI-driven energy management component is used to optimize power consumption and cooling efficiency using real-time data. The AI-driven energy management component monitors a plurality of operational parameters, such as the current energy load, environmental conditions, and available power sources. Based on the plurality of operational parameters, the AI-driven energy management component dynamically adjusts the power input from different nuclear reactors and renewable energy sources. The AI-driven energy management component may also predict energy spikes in computing workloads and adjust cooling levels to maintain optimal performance without overheating. For example, the AI-driven energy management component may train a model to detect that a data center is running intensive AI models or simulations; thus, the AI-driven energy management component increases power delivery from the nuclear reactor and adjusts the cooling subsystem to prevent thermal overload. Once the workload decreases, the AI-driven energy management component scales back energy consumption and cooling to maintain efficiency. An example of the reactor class mapping is shown in Table 1.

TABLE 1
Reactor class mapping

| | Output | | | |
|---|---|---|---|---|
| Reactor | Range | Suitable | Data Center | Cooling |
| Type | (Mwe) | Deployment | Size (racks) | Demand |
| Microreactor | 1-10 | Tactical, coastal | <50 | Light |
| MSR | 100-300 | Regional, sub-sea | 100-500 | Moderate |
| HTGR | 200-500+ | Permanent/strategic | >500 | Heavy |

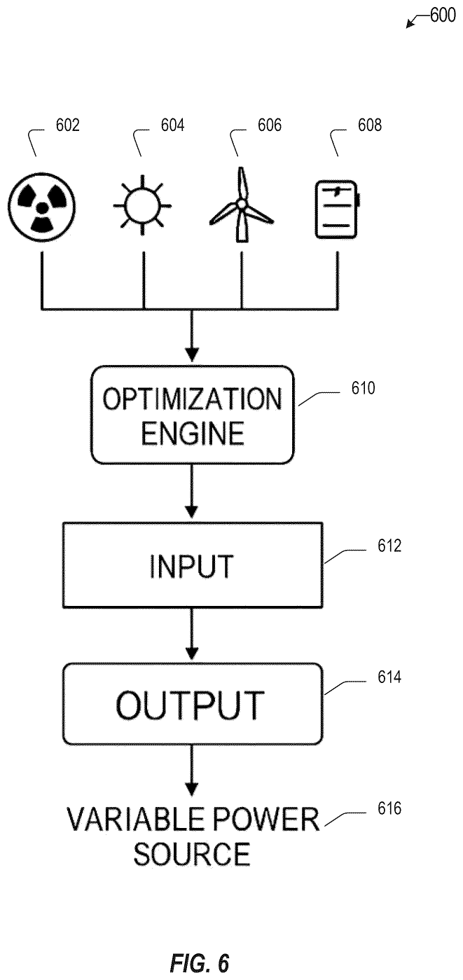

FIG. 6 illustrates a decision-making framework 600 of a mobile nuclear-powered data center platform in accordance with one or more embodiments. Decision-making framework 600 includes an onboard optimization engine 610 that is configured to evaluate and switch between different power sources, such as a nuclear power source 602, a solar power source 604, a wind power source 606, and a hydrogen tank 608. For example, onboard optimization engine 610 is implemented to train a model using an ML algorithm, such as an artificial neural network (ANN), to determine a power output forecast 614 associated with a variable power source 616 based on a plurality of input parameters 612. The model is determined by solving an optimization problem based on a predetermined objective. For example, the predetermined objective is to maximize the performance of nuclear power or the lifespan of the hydrogen tank. As another example, the predetermined objective is to minimize the cooling demand of the nuclear power source and the data center on the platform. Onboard optimization engine 610 may use the trained model to determine the power output forecast 614 associated with the variable power source 616. As a result, decision-making framework 600 may dynamically switch between different power sources to adjust the power output to meet the demand of the data center.

In some embodiments, the plurality of input parameters include a load forecast, a nuclear reactor power input, a solar power input, a wind power input, a hydrogen tank state of charge (SOC), one or more cooling parameters, and one or more regulatory operating constraints. The load forecast is determined based on a server demand for a plurality of HPC/AI workloads for a plurality of computing server racks in a data center of the mobile nuclear-powered data center platform. The nuclear reactor power input includes an available energy input from nuclear power source 602, such as a microreactor, an MSR, and an HTGR. The solar power input includes an available energy input from solar power source 604. The wind power input includes an available energy input from wind power source 606. The hydrogen tank's SOC is a percentage of the hydrogen tank's capacity that is currently filled with hydrogen as a fuel. The one or more cooling parameters include a cooling capacity and an ambient seawater temperature. The one or more regulatory operating constraints include no-fuel-cell during docked maintenance, nuclear safety standards, and other regulatory compliance features. For example, onboard optimization engine 610 receives a load forecast of 100 Mwe for the demand of the plurality of HPC/AI workloads to be consumed by the HPC clusters of the data center, a solar power input of 5 Mwe, a wind power input of 5 Mwe, and a hydrogen tank SOC of 50%. Based on the plurality of input parameters, onboard optimization engine 610 is implemented to apply the trained model to predict the power output forecast 614 (e.g., 100 Mwe) associated with the variable power source 616 that includes different contributions from one or more nuclear reactors (e.g., 30% from the microreactor, 25% from the MSR, and 25% from the HTGR), the solar power input (e.g., 5%), the winder power input (e.g., 5%), and the hydrogen tank (e.g., 10%).

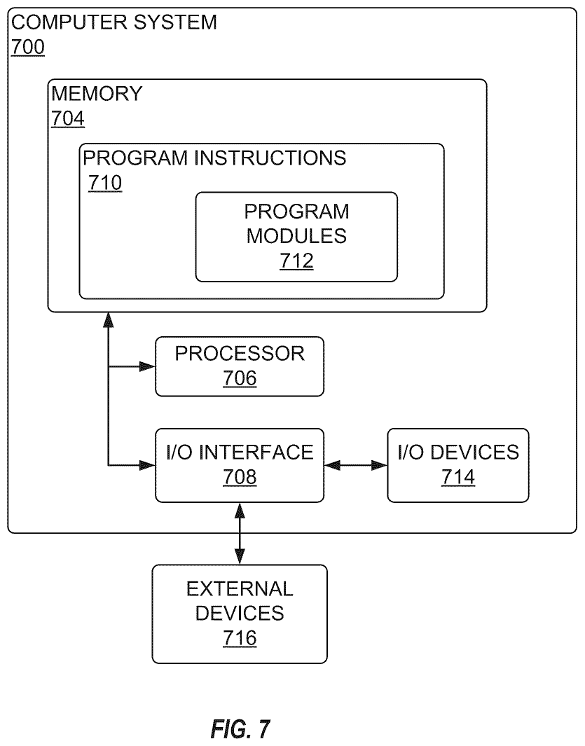

FIG. 7 is a functional block diagram of a computer system (or “system”) 700 in accordance with one or more embodiments. In some embodiments, system 700 is a programmable logic controller (PLC). System 700 may include memory 704, processor 706, and input/output (I/O) interface 708. Memory 704 may include non-volatile memory (for example, flash memory, read-only memory (ROM), programmable read-only memory (PROM), erasable programmable read-only memory (EPROM), electrically erasable programmable read-only memory (EEPROM)), volatile memory (for example, random access memory (RAM), static random access memory (SRAM), synchronous dynamic RAM (SDRAM)), or bulk storage memory (for example, CD-ROM or DVD-ROM, hard drives). Memory 704 may include a non-transitory computer-readable storage medium (for example, a non-transitory program storage device) having program instructions 710 stored thereon. Program instructions 710 may include program modules 712 that are executable by a computer processor (for example, processor 706) to cause the functional operations described, such as those described with regard to mobile semi-submerged data center platform 100 and mobile submerged data center platform 200.

Processor 706 may be any suitable processor capable of executing program instructions. Processor 706 may include a central processing unit (CPU) that carries out program instructions (for example, the program instructions of the program modules 712) to perform the arithmetical, logical, or input/output operations described. Processor 706 may include one or more processors. I/O interface 708 may provide an interface for communication with one or more I/O devices 714, such as a joystick, a computer mouse, a keyboard, or a display screen (for example, an electronic display for displaying a graphical user interface (GUI)). I/O devices 714 may include one or more of the user input devices. I/O devices 714 may be connected to I/O interface 708 by way of a wired connection (for example, an Industrial Ethernet connection) or a wireless connection (for example, a Wi-Fi connection). I/O interface 708 may provide an interface for communication with one or more external devices 716. In some embodiments, I/O interface 708 includes one or both of an antenna and a transceiver. In some embodiments, external devices 716 include external servers described in connection with mobile semi-submerged data center platform 100 and mobile submerged data center platform 200.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described herein are to be taken as examples of embodiments. Elements and materials may be substituted for those illustrated and described herein, parts and processes may be reversed or omitted, and certain features of the embodiments may be utilized independently, all as would be apparent to one skilled in the art after having the benefit of this description of the embodiments. Changes may be made in the elements described herein without departing from the spirit and scope of the embodiments as described in the following claims. Headings used herein are for organizational purposes only and are not meant to be used to limit the scope of the description.

It will be appreciated that the processes and methods described herein are example embodiments of processes and methods that may be employed in accordance with the techniques described herein. The processes and methods may be modified to facilitate variations of their implementation and use. The order of the processes and methods and the operations provided may be changed, and various elements may be added, reordered, combined, omitted, modified, and so forth. Portions of the processes and methods may be implemented in software, hardware, or a combination of software and hardware. Some or all of the portions of the processes and methods may be implemented by one or more of the processors/modules/applications described here.

As used throughout this application, the word “may” is used in a permissive sense (that is, meaning having the potential to), rather than the mandatory sense (that is, meaning must). The words “include,” “including,” and “includes” mean including, but not limited to. As used throughout this application, the singular forms “a,” “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A or B may refer to the element including one or both of A and B. As used throughout this application, the phrase “based on” does not limit the associated operation to being solely based on a particular item. Thus, for example, processing “based on” data A may include processing based at least in part on data A and based at least in part on data B, unless the content clearly indicates otherwise. As used throughout this application, the term “from” does not limit the associated operation to being directly from. Thus, for example, receiving an item “from” an entity may include receiving an item directly from the entity or indirectly from the entity (for example, by way of an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic or magnetic quantities within memories, registers, or other information storage devices, transmission devices, or display devices of the special purpose computer or similar special purpose electronic processing/computing device.

At least one embodiment is disclosed and variations, combinations, modifications of the embodiment(s), or features of the embodiment(s) made by a person having ordinary skill in the art are within the scope of the disclosure. Alternative embodiments that result from combining, integrating, or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (for example, from about 1 to about 10 includes, 2, 3, 4, etc.; greater than 0.10 includes 0.11, 0.12, 0.13, etc.). The use of the term “about” (or its variants) means±10% of the subsequent number, unless otherwise stated.

Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise.

Many other embodiments will be apparent to those of skill in the art upon reviewing the above description. The scope of the subject matter of the present disclosure therefore should be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A mobile nuclear-powered data center system, comprising:
a mobile platform configured for transport to and deployment at a predetermined location, the mobile platform having infrastructure to support both nuclear power generation and data center operation;
a nuclear reactor assembly mounted on the mobile platform, the nuclear reactor assembly comprising a nuclear reactor configured to generate electric power, a containment structure enclosing the nuclear reactor for safety, and a first cooling subsystem for removing heat dissipated from the nuclear reactor;
a data center module mounted on the mobile platform comprising a plurality of computing servers, data storage devices, and networking equipment, the data center module having an onboard power distribution subsystem to supply power to the plurality of computing servers;
an electrical interface electrically coupling the nuclear reactor assembly to the onboard power distribution subsystem of the data center module, such that the plurality of computing servers are powered at least in part by electricity generated by the nuclear reactor;
an energy storage and backup subsystem integrated with the mobile platform to store excess electrical energy generated during periods of low computing load and to supply supplemental electrical power to the data center module during periods of high load or the nuclear reactor shutdown;
an integrated control component configured to monitor and regulate an electric power supply based on a computing demand for the data center module; and
one or more safety subsystems mounted on the mobile platform, the one or more safety subsystems comprising radiation shielding, a reactor shutdown subsystem, and an emergency cooling subsystem, the one or more safety subsystems configured to ensure the nuclear reactor assembly operates within safe parameters and to protect personnel and equipment, thereby enabling the mobile platform to meet nuclear regulatory requirements for transportable or maritime reactors.

2. The system of claim 1, wherein the mobile platform is a floating vessel or barge structured to comply with maritime safety standards for nuclear-powered ships, comprising compliance with Safety of Life at Sea (SOLAS) Chapter VIII and class society rules for nuclear vessel design, such that the mobile platform is deployed in harbors or international waters with regulatory approval.

3. The system of claim 1, wherein the nuclear reactor assembly is a small modular reactor (SMR) with a thermal power output between 10 megawatts thermal (MWt) and 300 MWt, and is designed for inherent safety through passive cooling and autonomous shutdown, the nuclear reactor assembly further using a high-assay low-enriched uranium fuel to allow a core operation lifespan of at least 3 years between refueling.

4. The system of claim 1, wherein the energy storage and backup subsystem comprises:
an electrolysis unit configured to use surplus electrical power from the nuclear reactor to generate hydrogen;
a plurality of hydrogen storage tanks for storing the generated hydrogen; and
one or more hydrogen fuel cells capable of converting the stored hydrogen back into electricity, so that the energy storage and backup subsystem provides a hydrogen-based energy buffer for load leveling and emergency power, thereby reducing the need for external grid support or fossil-fuel generators.

5. The system of claim 1, further comprising:
a renewable energy interface that allows the mobile platform to import or export electrical power to one or more external renewable energy sources; and
a control system configured to dynamically balance power from the nuclear reactor and the one or more external renewable energy sources to maintain continuous power to the data center module.

6. The system of claim 1, further comprising:
an integrated cooling subsystem by combining the first cooling subsystem for the nuclear reactor assembly with a second cooling subsystem for the data center module using a common heat sink,
wherein the integrated cooling subsystem uses seawater pumps and heat exchangers to dissipate reactor waste heat and cool the data center equipment, enabling high-efficiency heat removal and eliminating the need for large cooling towers on the mobile platform.

7. The system of claim 1, further comprising:
a remote monitoring subsystem that is automated to adjust a plurality of operations for the nuclear reactor and the data center module, wherein the plurality of operations are determined using redundant sensors and control algorithms that manage reactor power levels, data center power usage, and safety interlocks without continuous human intervention.

8. The system of claim 1, further comprising a plurality of modular connectors and coupling mechanisms that allow a plurality of mobile nuclear-powered data center subsystems to be linked together electrically and/or mechanically when deployed, thereby forming a larger aggregated data center complex with increased computing and power capacity.

9. The system of claim 1, wherein the data center module comprises a communication interface for data connectivity, the communication interface comprising at least one high-bandwidth fiber optic link or satellite communication system, allowing the data center module to serve remote clients or integrate into a wider network.

10. A method of deploying a mobile nuclear-powered data center platform, comprising:
transporting the mobile nuclear-powered data center platform that includes a nuclear reactor assembly and a data center module to a first location, the reactor assembly comprising a nuclear reactor configured to generate electric power;
mooring or installing the mobile nuclear-powered data center platform at the first location and initiating the nuclear reactor assembly to generate electric power in a power supply for a plurality of computing servers associated with the data center module;
powering, using an electrical interface, electrically coupling the nuclear reactor assembly to the onboard power distribution subsystem of the data center module, the plurality of computing servers associated with the data center module at least in part by the electric power generated by the nuclear reactor assembly;
receiving, using an integrated control component, a computing demand for the data center module from a user;
monitoring and regulating, using the integrated control component, the electric power supply based on the computing demand;
implementing, using one or more safety subsystems, a plurality of safety and security protocols during an operation of the mobile nuclear-powered data center platform, the operation comprising continuous cooling of the nuclear reactor, radiation monitoring, and the capability to reactor protection system actuation (SCRAM) the nuclear reactor in case of emergency, and maintaining secure network communication for the data center module;
receiving, using the integrated control system, a command to transport the mobile nuclear-powered data center platform to a second location; and
upon receiving the command, relocating the mobile nuclear-powered data center platform from the first location to the second location by implementing a plurality of steps comprising ceasing data operations, shutting down the nuclear reactor to a safe transport state, and moving the mobile nuclear-powered data center platform.

11. The method of claim 10, further comprising:
directing, using the integrated control component, excess power to an energy storage and backup subsystem when the computing demand is lower than a current power output from the nuclear power module; and
directing, using the integrated control component, a supplemental power from the energy storage and backup subsystem or by adjusting current power output from the nuclear power module.

12. The method of claim 10, wherein the first and second locations include a port or coastal site within a country, an offshore position in international waters, and a remote land site lacking grid infrastructure.

13. The method of claim 10, further comprises:
activating a communications link from the mobile nuclear-powered data center platform to a land-based network hub to transfer data from the mobile nuclear-powered data center platform to the user.

14. The method of claim 10, further comprising:
connecting an output feeder from the onboard power distribution subsystem to an external facility; and
supplying auxiliary power to the external facility without interrupting the electric power supply for the data center module.

15. The method of claim 10, further comprising:
measuring a change in the computing demand for the data center module;
in response to detecting the change, dynamically controlling, using a feedback loop, a power level of the nuclear reactor by adjusting control rods or coolant flow in the nuclear reactor to increase/decrease electrical generation, within predetermined safe ramping rates, thereby accomplishing fine-grained load following to minimize reliance on stored energy.

16. The method of claim 10, further comprising:
periodically performing maintenance and refueling operations for the nuclear reactor assembly on-site or at a refueling facility.

17. A transportable data center platform, comprising:
a structural body adapted for transit and redeployment, the body housing both (i) a power generation section containing a nuclear reactor and associated power conversion hardware, and (ii) a data processing section containing racks of computing equipment;
a plurality of modular connection points on the body for external interfaces, comprising at least one power interface for connecting to an external electrical grid or renewable energy source, and at least one data interface for connecting to telecommunications networks; and
a hybrid power management system that controls the distribution of electrical power from the power generation section to the data processing section and the external power interface, the power management system comprising control circuitry to manage power flows, energy storage utilization, and failover to backup power;
wherein the nuclear reactor in the power generation section is an inherently safe microreactor designed to have a limited emergency planning zone contained within the transportable platform, and the platform is constructed to comply with at least one national or international nuclear safety standard applicable to mobile reactors; and
wherein the data processing section is configured to operate as a secure data center environment with controlled temperature, humidity, and physical security, such that the entire platform can provide data center services independently of location while meeting applicable safety, security, and liability requirements for nuclear-powered operations.

18. The transportable data center platform of claim 17, wherein the nuclear reactor is a fusion reactor or advanced fission reactor that produces minimal long-lived radioactive waste.

19. The transportable data center platform of claim 17, wherein the transportable data center platform further comprises a radiation-hardened infrastructure for the data processing section, comprising electronic components and shielding that protect the computing equipment from any residual radiation or electromagnetic interference emitted by the reactor section.

20. The transportable data center platform of claim 17, wherein a plurality of transportable data center platforms are aggregated to form a distributed cloud network, each platform located in a corresponding geographic region and interconnected via high-speed data links.
